(19) United States
(12) Patent Application Publication
(10) Pub. No.: US 2016/0180423 A1
(43) Pub. Date: Jun. 23, 2016

(54) SYSTEM AND METHOD FOR QUEUEING VIDEO CALLS

(71) Applicant: Jonathan Defoy, Brossard (CA)

(72) Inventor: Jonathan Defoy, Brossard (CA)

(21) Appl. No.: 14/651,151

(22) PCT Filed: Dec. 10, 2013
(86) PCT No.: PCT/CA2013/001023

§ 371 Date: Jun. 10, 2015

Related U.S. Application Data
(60) Provisional application No. 61/737,351, filed on Dec. 14, 2012.

(51) Int. Cl. G06Q 30/06; G06Q 10/06; H04N 7/14

(52) U.S. Cl. CPC G06Q 30/0613; H04N 7/147; G06Q 10/06316

(57) ABSTRACT

A queueing method for ranking users of a live interactive remote video shopping platform, the method comprising: receiving an identification for at least two users who requested to interact with a given merchant via a live video call, and for each one of the at least two users, an identification of a respective item for which the live video call was requested; retrieving, from a database and for each user, item information about the respective item; determining, for each one of the at least two users, at least one characteristic of a respective video call system; ranking the at least two users as a function of the item information, the at least one characteristic of the video call systems, and a set of predefined rules, thereby obtaining a running order of the at least two users for video calls with the given merchant; and outputting the running order.

### CROSS-REFERENCE TO RELATED APPLICATIONS

This application claims priority of US Provisional patent application having Ser. No. 61/737,351, which was filed on Dec. 14, 2012 and is entitled “System and method for live interactive remote video shopping”, the specification of which is hereby incorporated by reference.

### TECHNICAL FIELD

The present invention relates to the field of methods and system for queueing video calls, particularly in a context of live interactive and remote video shopping.

### BACKGROUND

Electronic commerce allows merchants to reach customers without requiring the customers to be physically in the merchant stores. For example, many merchants have integrated an electronic payment platform to their website so that a customer visiting the website of a merchant may purchase items directly from the website. However, the information about items contained in a website is often limited. In addition, a merchant website usually offer substantially no possibility for the customers to interact with the merchant. For example, some merchant website offers to customers the possibility to text chat with the merchant. However, the interactions between the customers and the merchants via text chat are limited. Shopping engines usually suffer the same deficiencies as merchants websites.

A live video platform which connects customers to merchants via video may be used to allow the customers to interact with the merchants and improve their shopping experience. In this case, queueing must be used to queue the customers requesting a video call with a same merchant. While queueing methods exist for distributing phone calls, such methods may not be adapted to queue video calls.

Therefore there is a need for a method and system for queueing video calls in the context of a video call shopping platform.

### SUMMARY

In accordance with a first broad aspect, there is provided a queuing method for ranking users of a live interactive remote video shopping platform, the method comprising: receiving an identification for at least two users who requested to interact with a given merchant via a live video call, and for each one of the at least two users, an identification of a respective item for which the live video call was requested; retrieving, from a database and for each user, item information about the respective item; determining, for each one of the at least two users, at least one characteristic of a respective video call system; ranking the at least two users as a function of the item information, the at least one characteristic of the video call systems, and a set of predefined rules, thereby obtaining a running order of the at least two users for video calls with the given merchant; and outputting the running order.

In one embodiment, the item information comprises at least one of the model of the item, the color of the item, the price of the item, the availability of the item, the inventory, the shipping options associated with the item, the store pick-up options, or the like.

In one embodiment, the at least one characteristic of the respective video call system comprises at least one of a software characteristic of the video call system, a hardware characteristic of the video call system, and an Internet connection characteristic.

In one embodiment, the software characteristic comprises a type of an operating system, a version of the operating system, a type of an Internet browser, a version of the Internet browser, a type of a firewall, and a version of the firewall.

In one embodiment, the hardware characteristic comprises at least one of a performance of a type of the video call system, a model of a the video call system, a processor contained in the video call system, a resolution of a display unit of the video call system, a resolution of a camera contained in the video call system, a type of the camera, a model of the camera, a type of a firewall, and a version of the firewall.

In one embodiment, the step of determining the at least one characteristic of the respective video call system comprises using a fingerprinting method.

In one embodiment, the method further comprises a step of determining at least one user attribute for each one of the at least two users, and said ranking of the at least two users is further performed as a function of the at least one user attribute.

In one embodiment, the method further comprises a step of determining at least one business attribute for each one of the at least two users, and said ranking the at least two users is further performed as a function of the at least one business attribute.

In one embodiment, the method further comprises a step of determining at least one attribute of a compatibility between a video call system of the given merchant and the video call system of each one of the at least two users, and said ranking the at least two users is further performed as a function of the at least one attribute of the compatibility.

In one embodiment, the step of ranking comprises assigning, for each one of the at least two users, a first individual score for the item information using a first one of the predefined rules and a second individual score for the at least one characteristic of the respective video call system using a second one of the predefined rules, and determining for each one of the at least two users a total score using the first and second individual scores, the ranking being performed as a function of the total scores.

In one embodiment, the item comprises a service and the item information comprises at least the type of the service.

According to another broad aspect, there is provided a queueing device for ranking users of a live interactive remote video shopping platform, the method comprising: an item module adapted to receive, for each one of at least two users who requested to interact with a given merchant via a live video call, an identification of a respective item for which the live video call was requested, and retrieve, from a database and for each user, item information about the respective item; a video system unit adapted to receive an identification for each one of the at least two users; and determine, for each one of the at least two users, at least one characteristic of a respective video call system; a ranking module adapted to rank the at least two users as a function of the item information, the at least one characteristic of the video call systems, and a set of predetermined rules, thereby obtaining a running order of the at least two users for video calls with the given merchant, and output the running order.

In one embodiment, the software characteristic comprises a type of an operating system, a version of the operating system, a type of an Internet browser, a version of the Internet browser, a type of a firewall, and a version of the firewall.

In one embodiment, the hardware characteristic comprises at least one of a performance of a type of the video call system, a model of the video call system, a processor contained in the video call system, a resolution of a display unit of the video call system, a resolution of a camera contained in the video call system, a type of the camera, a model of the camera, a type of a firewall, and a version of the firewall.

In one embodiment, the video system unit is adapted to determine the at least one characteristic of the respective video call system using a fingerprinting method.

In one embodiment, the queueing device further comprises a user unit adapted to determine at least one user attribute for each one of the at least two users, the ranking unit being further adapted to rank the at least two users as a function of the at least one user attribute.

In one embodiment, the queueing device further comprises a business unit adapted to determine at least one business attribute for each one of the at least two users, the ranking unit being further adapted to rank the at least two users as a function of the at least one business attribute.

In one embodiment, the queueing device further comprises a compatibility unit adapted to determine at least one attribute of a compatibility between a video call system of the given merchant and the video call system of each one of the at least two users, the ranking unit being further adapted to rank the at least two users as a function of the at least one attribute of the compatibility.

In one embodiment, the item module is adapted to assign, for each one of the at least two users, a first individual score for the item information using a first one of the predetermined rules, the video system unit is adapted to assign a second individual score for the at least one characteristic of the respective video call system using a second one of the predetermined rules, and the ranking unit is adapted to determine for each one of the at least two users a total score using the first and second individual scores, the ranking being performed as a function of the total scores.

In one embodiment, the item is a product offer for sale by a merchant or a retailer. In another embodiment, the item is a service. For example, the service may be offered for sale by a merchant, i.e. a service provider.

### BRIEF DESCRIPTION OF THE DRAWINGS

Further features and advantages of the present invention will become apparent from the following detailed description, taken in combination with the appended drawings, in which:

FIG. 1 is a block diagram of a system for interactive video sales comprising a search engine, a video call unit, and a database, in accordance with an embodiment;

FIG. 2 is a block diagram of a system for interactive video sales comprising a profile manager unit, search engine, a video queueing unit, a video call unit, a purchase unit, an analytics and statistics unit, and a database, in accordance with an embodiment;

FIG. 3 illustrates a method followed by a user for creating a user account, in accordance with an embodiment;

FIG. 4 illustrates a method followed by a merchant for creating a user account, in accordance with an embodiment;

FIG. 5 illustrates a method followed by a merchant for accessing a merchant dashboard, in accordance with an embodiment;

FIG. 6 illustrates a merchant public page, in accordance with an embodiment;

FIG. 7 illustrates a method for allowing interactive video sales between a customer and a merchant, in accordance with an embodiment;

FIG. 8 illustrates a method for searching for an item using the search engine of the system of FIG. 2, in accordance with an embodiment;

FIG. 9 illustrates an exemplary search page interface provided to a customer;

FIG. 10 illustrates one exemplary interface for presenting search results;

FIG. 11 illustrates one exemplary interface for managing queued video calls;

FIG. 12 illustrates an exemplary interface for placing a live video call;

FIG. 13 is a flow chart of a method for queueing users having requested a video call with a same merchant, in accordance with an embodiment;

FIG. 14 is a block diagram of a video call queueing unit, in accordance with an embodiment;

FIG. 15 illustrates one exemplary interface for scheduling a video call;

FIG. 16 illustrates a video call panel, in accordance with an embodiment;

FIG. 17 illustrates an interface provided to a user during a video call, in accordance with an embodiment;

FIG. 18 illustrates an interface provided to a merchant during a video call, in accordance with an embodiment;

FIG. 19 illustrates a method followed by a user after a video call, in accordance with an embodiment;

FIG. 20 illustrates a method followed by a merchant after a video call, in accordance with an embodiment; and

FIG. 21 is a flow chart illustrating a method for generating analytics and statistics data, in accordance with an embodiment.

It will be noted that throughout the appended drawings, like features are identified by like reference numerals.

### DETAILED DESCRIPTION

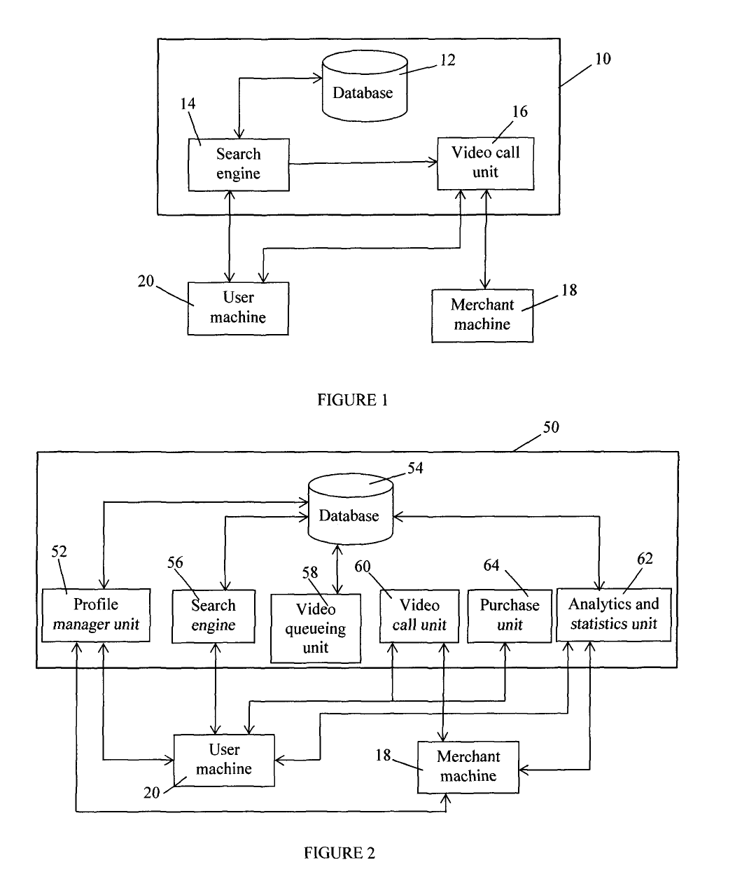

FIG. 1 illustrates one embodiment of a web platform system 10 for allowing interactive video interactions and/or sales between customers and merchants or retailers. It should be understood that the terms “merchant” and “retailer” and the terms “user”, “consumer”, and “customer” may be interchangeably used throughout the below description. The web platform system 10 comprises a database 12 for storing data, a search engine 14, and a video call unit 16.

The database 12 comprises at least a list of merchants and corresponding information. For each merchant, the information stored in the database may comprise information such as information about items to be sold by the merchant, information identifying a merchant machine 18 such as an Internet Protocol (IP) address, etc. For each item stored in the database, the item information may comprise a name, an item ID, a category, a description, a price, specifications, an availability, delivery options, store pick-up options, and/or the like. It should be understood the database 12 may comprise no item information. In this case, the search engine may be connected to the Point-Of-Sale (POS) system and/or the inventory system of the merchants in order to retrieve the item information.

The search engine 14 is adapted to allow a customer connected to the web platform system 10 via a customer machine 20 to perform a search, and to return the search results to the customer machine 20.

In one embodiment, the customer may search for a desired item. In this case, the customer sends a query defining the desired item to the search engine 14. The search engine 14 is then adapted to determine a list of items from the database 12 that correspond to the queried item and return the list of items to the customer machine 20. Furthermore, for each item contained in the list, item information in addition to the name of the merchant that offers the item for sale is sent to the customer machine 20.

The user then selects, from the received list, a desired item for which he would like to interact with the merchant offering for sale the selected item via a live video connection, and an identification of the selected item is sent from the user machine 20 to the search engine 14. The search engine 14 then sends an identification of the user, an identification of the selected item, and an identification of the merchant offering the selected item for sale to the video call unit 16. The video call unit 16 retrieves the IP addresses of the user and the merchant and sends to the merchant machine 18 a message indicative that a user would like to interact with an operator of the merchant in a video call. The message may further be indicative of the item selected by the user. Upon reception of a message indicating that an operator or employee of the merchant accepts the video call from the merchant machine 18, the video call unit generates a video connection between the user machine 20 and the merchant machine 18.

In another embodiment, the user may search for an item category or a store department, such as electronics, appliances, sofas, or the like. In this case, the customer machine 20 sends, to the search engine 14, a query indicative of a desired item category or store department, and the search engine 14 returns a list of merchants that offer items contained in the desired item category or store department. The user may then select a desired merchant and an indication of the selected merchant is sent from the user machine 20 to the search engine 14. The search engine 14 then sends an identification of the user and an identification of the merchant to the video call unit 16. The search engine may further sends an identification of the selected item category to the video call unit 16. The video call unit 16 retrieves the IP addresses of the user and the merchant and sends, to the merchant machine 18, a message indicative that a user would like to interact with an operator of the merchant in a video call to the merchant machine 18. The message may further be indicative of the item category selected by the user. Upon reception of a message indicating that the operator of the merchant accepts the video call from the merchant machine 18, the video call unit 16 generates a video connection between the user machine 20 and the merchant machine 18.

In a further embodiment, the user may search for a given merchant with whom he would like to interact in a video call. The user may enter a query indicative of a desired merchant, and the query is sent from the user machine 20 to the search engine 14. In another embodiment, the search engine 14 sends a list of available merchants to the user machine 20 and the user selects a desired merchant from the list. The selected merchant is then sent from the user machine 20 to the search engine 14 which transmits an identification of the user and an identification of the selected merchant to the video call unit 16. The video call unit 16 retrieves from the database 12 the IP addresses corresponding to the user and the selected merchant previously stored therein. The video call unit 16 sends to the merchant machine 18 a message indicative that a user would like to interact via an interactive live video call with an operator of the merchant. Upon reception of a message indicating that the operator of the merchant accepts the video call from the merchant machine 18, the video call unit generates a video connection between the user machine 20 and the merchant machine 18.

It should be understood that the identification of the user and the merchant sent by the search engine 14 to the video call unit 16 may be their respective IP address.

Alternatively, any user or merchant ID may be used, and the search engine 14 then retrieves the IP addresses of the user and the merchant from the database 12 using the user and merchant IDs.

FIG. 2 illustrates one exemplary embodiment of a system 50 for creating a live interactive video connection between a user and a merchant. The system 50 comprises a profile manager unit 52, a database 54 stored in a memory or storing unit, a search engine 56, a video queueing unit 58, a video call unit 60, an analytics and statistics unit 62, and a purchase unit 64.

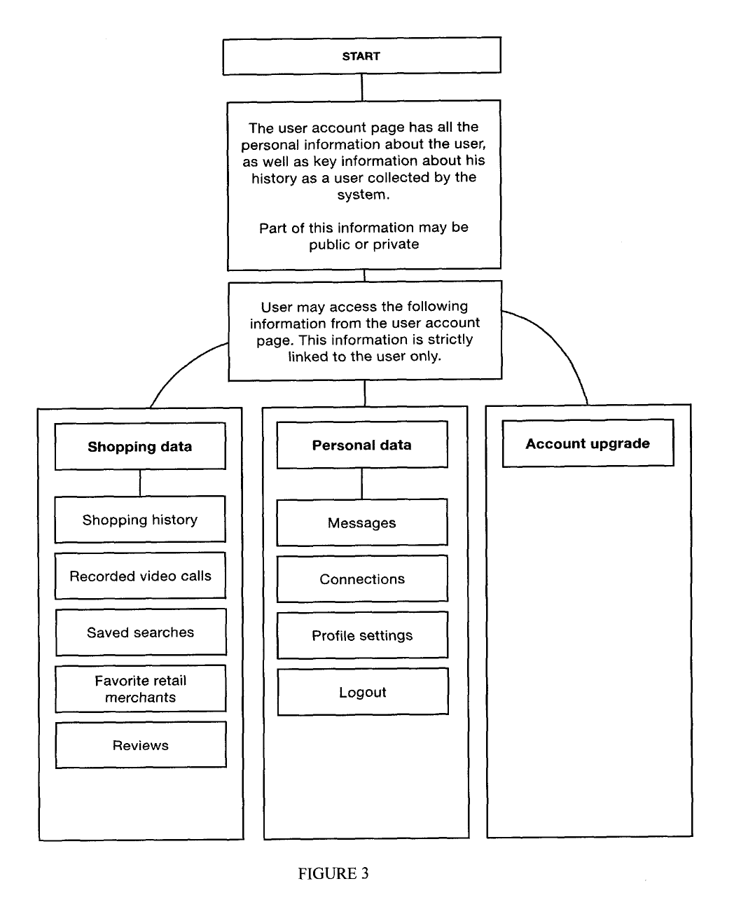

The profile manager unit 52 is adapted to allow the users and the merchants to create, manage, and update their account, and also create their public profile. Upon a first connection to the system 50, a user is requested to create an account. The profile manager unit 52 requests the user to input personal information such as a name, an address, a phone number, an email address, a password, and/or the like to create an account which is stored in the database 54. Once created, the user may manage and update his account via the profile manager unit 52, as illustrated in FIG. 3. For example, the user may save a list of favorite merchants, a list of shopping interests, reviews about merchants and/or products, a wish-list of items, and/or the like. This additional information is stored in the user account within the database 54. The user may subsequently save, in his user account, searches performed via the system 50, video calls recorded while using the system 50, and/or the like.

The profile manager unit 52 is further adapted to create a public profile for the user, which may be accessed by merchants and other users. The public profile comprises information about the user that other users and merchants are authorized to access. Via the profile manager unit 52, the user may determine settings for his public profile. For example, the user may select which user information contained in the user account should be private and therefore not shared with other users or merchants, and which user information may be shared with other users and merchants, and therefore should be contained in his public profile. The user may also restrict the access to some parts of his public profile to predetermined users and/or merchants. In one embodiment, the user may decide not to create a public profile so that no other users and no merchants may have access to information about the user.

Via the profile manager unit 52, the user may further define a list of connections, i.e. a list of other users that have also created an account or an account and a public profile. The user may also receive messages from his connections and from the merchants that he included in his list of favorite merchants, which are stored in the database 54. The user may then consult the received messages via the profile manager unit 52. The user may further write and send messages to his connections and/or to merchants via the profile manager unit 52. In one embodiment, the profile manager unit 52 is adapted to send an email or a Short Message Service (SMS) message to the user upon reception of a message from another user or a merchant in order to inform the user of the received message. In one embodiment, the email or SMS message may contain the message sent by the other user or merchant.

As described below, the system 50 stores, in the database 54, a history of all video calls between users and merchants and any purchase made by the users. This history is referred hereinafter as the shopping history. The user may then access his shopping history from the profile manager unit 52.

The profile manager unit 52 is also used by a merchant for creating a merchant account which is stored in the database 54. In order to create the merchant account, the profile manager unit 52 requests the merchant to input business information. The business information comprises at least business contact information such as an address, an email address, the name of a contact person, a phone number, and/or the like.

In one embodiment, the business information further comprises item information about the items or products offered by the merchant for sale. For each item or product, the item information comprises a name, an ID, a description, specifications, a price, availability, a category, and/or the like.

In another embodiment, the business information further comprises a list of categories of items or products that the merchant offers for sale. Examples of items categories comprise: computers, home appliances, office furniture, etc. It should be understood that the list of item categories may be replaced by a list of retail departments for example.

In a further embodiment, the merchant enters no information about the items and products offered for sale in the database 54. In this case, the platform 50 may be connected to the POS system and/or the inventory system of the merchant to obtain item information.

In one embodiment, the merchant may further add marketing and Search Engine Optimization (SEO) information to his account via the profile manager unit 52, such as product descriptions, product specifications, keywords describing the items sold by the merchant, and/or the like.

In one embodiment, the merchant may add design information to his account via the profile manager unit 52. The design information may comprise the merchant's logo, brand, company corporate colors, etc. The design information may be included on the merchant public profile page.

It should be understood that other relevant information about the merchant may be included in his account. For example, the merchant may identify the areas in which he may deliver products to customers.

In one embodiment, the merchant may add videos presenting his store(s) for example, pictures of his store(s) for example, a logo of the company, and/or the like to his account via the profile manager unit 52.

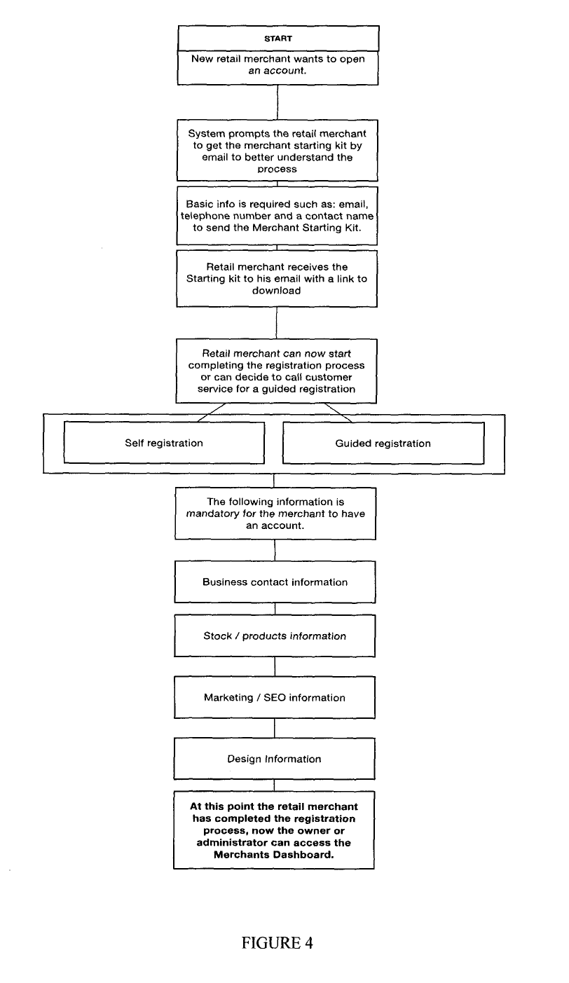

In one embodiment, the merchant may be provided with a starting kit comprising information about the process to create an account, as illustrated in FIG. 4. For example, while connecting for the first time to the system 50, a merchant may be asked to provide basic information such as an email address, a phone number, and the name of a contact person. The starting kit is then sent to the merchant by email. Alternatively, an email containing a URL link for downloading the starting kit may be sent to the merchant.

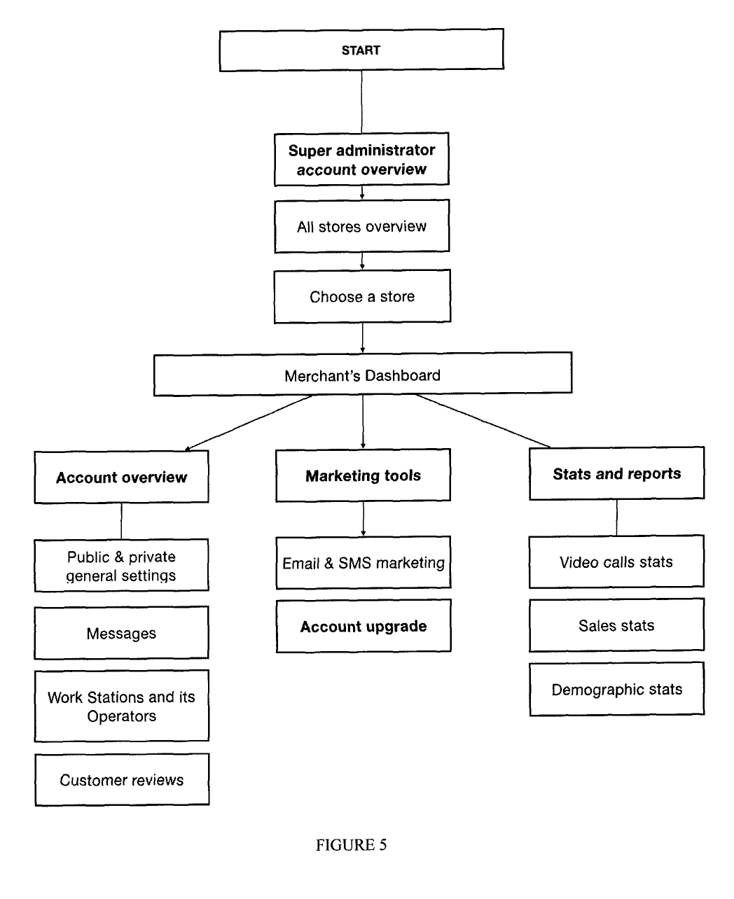

As illustrated in FIG. 5, an administrator of the merchant may access a merchant dashboard via the profile manager unit 52 once the account has been created. If the merchant possesses more than one store, the merchant account may comprise one merchant dashboard per store. In this case, the administrator is first requested to select a given store before accessing the merchant dashboard for the given store.

The merchant dashboard is an interface generated by the profile manager unit 52 through which the administrator may have access to the merchant account in order to update, modify, and/or expand the merchant account. For example, the administrator may decide which information contained in the merchant account is public or private. The public information will be accessible on a public merchant profile to users and optionally other merchants. Via the merchant dashboard, the administrator may access reviews written by users and information about the merchant machines or workstations and their operators, such as statistics on the performance of operators, operators ratings made by users, the number of video calls answered, the number of sales transactions completed, the average call duration, for example. The administrator may also write messages to be posted on the public merchant profile or to be sent to given users such as users who identified the merchant as one of their favorite merchants, and/or emails or SMS messages to be sent directly to given users of the system 50 for marketing purposes for example.

Via the merchant dashboard, the merchant may also have access to reports and statistics generated by the analytics and statistics unit 62, as described below. For example, the merchant may have access to statistics about video calls, sales, and/or demographic data on the merchant customers such as the average age, the percentage of male customers versus female customers, the average home distance from the store, etc.

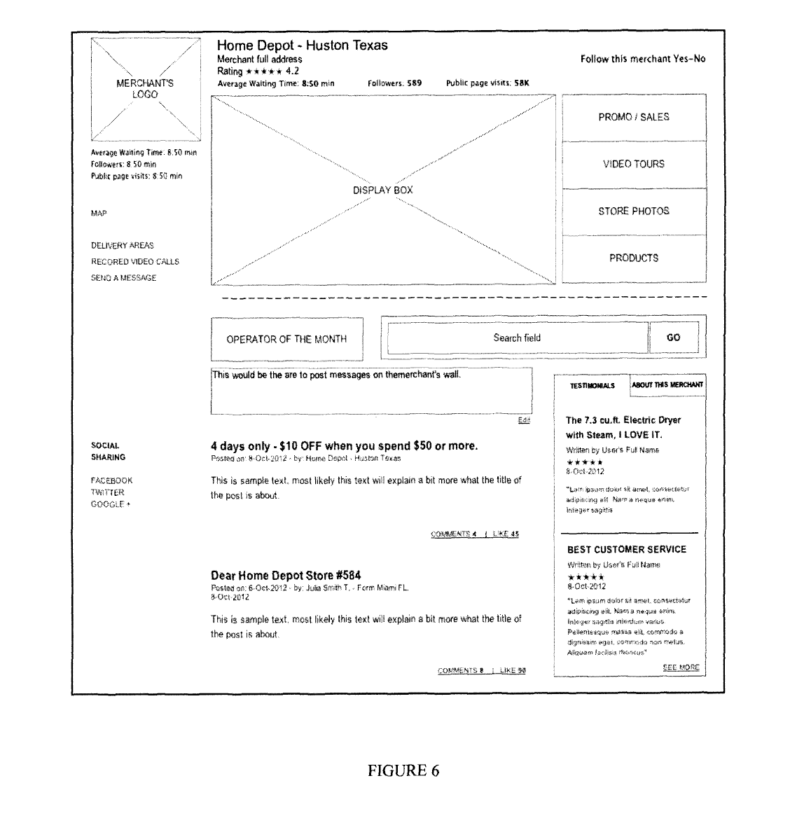

FIG. 6 illustrates one exemplary interface for a merchant public profile that may be generated by the profile unit 52. The interface comprises a first information section and a second social section. The first section comprises public information such as the name of the merchant, the merchant address, the merchant rating, an average waiting time before conducting a video call with the merchant, a number of users that follow the merchant, the number of visits of the merchant public page, and/or the like.

Furthermore, the merchant public profile may also provide links towards other information about the merchant. For example, the user may access videos and/or pictures presenting the merchant store(s) or products for example, sales promotions offered by the merchant, the list of products or items offered for sale by the merchant, a list of public video calls with the merchant previously recorded by other users, and/or information about the areas where the merchant may deliver products.

In the social section of the merchant public profile, the profile manager unit 52 may insert posts written by the merchant and/or users and being presented as a post wall. Testimonials from users may also be inserted in the social section of the public merchant profile.

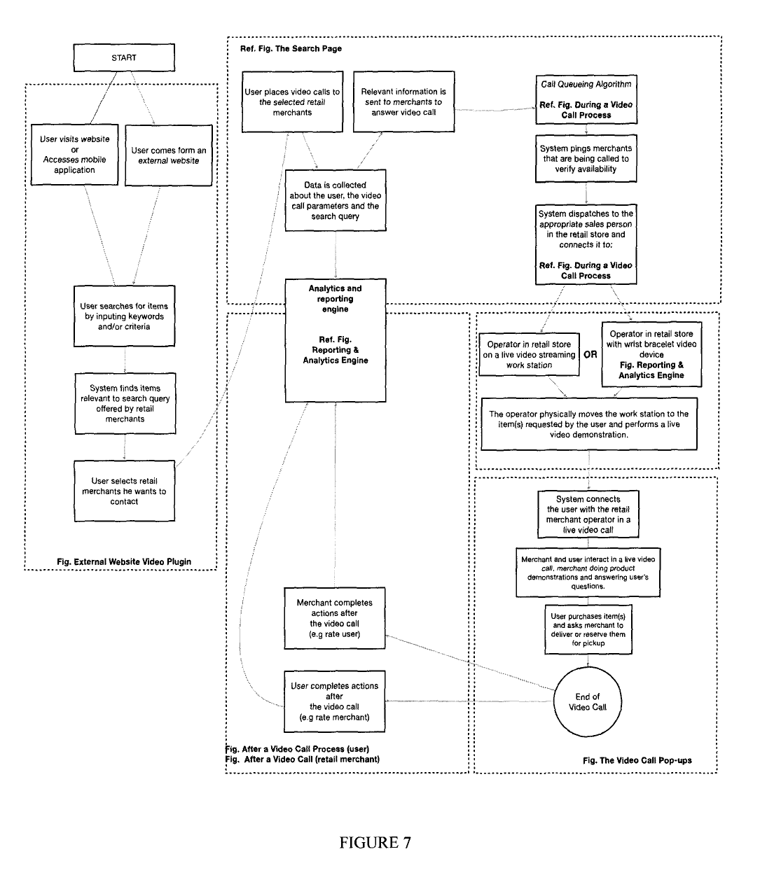

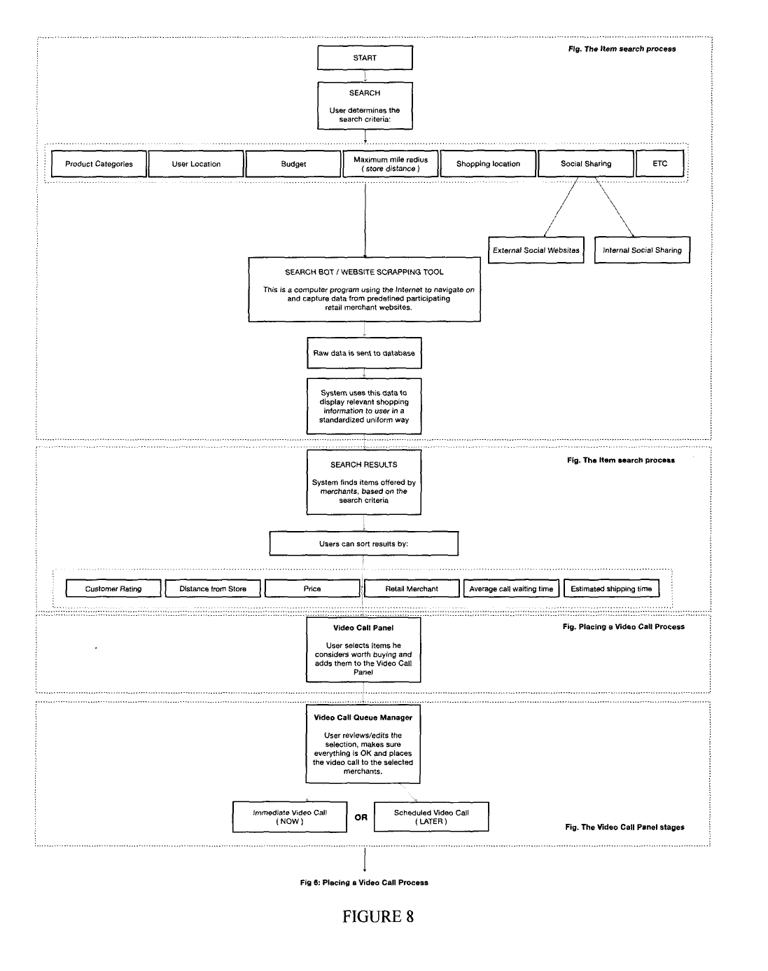

FIG. 7 illustrates one embodiment of a method for a user to conduct a video call with a merchant. The user starts by connecting to the system 50. The user enters identification information which is sent by his user machine 20 to the profile manager unit 52 in order to authenticate the user. The profile manager unit 52 transmits an interface that may be his user page or account to the user machine 20. The user selects to perform a search and the profile manager unit 52 directs the user to the search engine 56 which transmits a search interface to the user machine 20.

The user then inputs search keywords and/or criteria which are transmitted by the user machine 20 to the search engine 56. The search engine 56 retrieves items or products corresponding to the query and transmits information about the retrieved items to the user machine 20. The user selects a desired item from the list of received items and an identification of the selected item is transmitted from the user machine 20 to the search engine 56. The user further sends a confirmation message indicating that he would like to place a video call to the merchant corresponding to the selected information. As described below, the user may indicate a desired specific time for the video call, a desired estimated duration for the video call, and/or the like.

The search engine 56 stores in the database 54 information about the searched item, the user, and the video call parameters selected by the user, as described above. This information may subsequently be accessed by the analytics and statistics unit 62 for generating reports and statistics.

The search engine 56 further transmits information about the video call to the video queueing unit 58. The information about the video call comprises at least an identification of the user, an identification of the merchant, and an identification of the selected item. The video queueing unit 58 determines whether other users have requested a video call with the same merchant concurrently with the first user.

If no other users have requested a video call with the merchant, the video queueing unit 58 transmits the video call information to the video call unit 60.

If at least another user has requested a video call with a same given merchant, the video queueing unit 58 determines a priority order for the users defining a running order for the video calls with the merchant, as described below. The video queueing unit 58 then transmits the video call information for each user and their respective running order to the video call unit 60.

The video call unit 60 retrieves, from the database 54, information identifying the merchant and user machines 18 and 20, such as their IP address, using the received identification for the user and the merchant. The video call unit 60 transmits, to the merchant machine 18, a message indicating that a user is waiting for a video call to the merchant machine 18 in order to verify the availability of the merchant for a live video call with the user. Upon reception of a confirmation message from the merchant, the video call unit 60 creates a video connection between the user machine 20 and the merchant machine 18.

In an embodiment in which the merchant has more than one merchant machine 18, the merchant account comprises an identification for each merchant machine 18 and at least one respective item category or store department assigned to each merchant machine 18. The video call unit 60 first determines which merchant machine 18 should be connected to the user machine 20, and then connects the user machine 20 to the determined merchant machine 18. In one embodiment, the video call unit 60 compares the item selected by the user to the different item categories or department stores of the merchant and determines the adequate merchant machine 18 as being the merchant machine 18 corresponding to the item category or department store to which the selected item belongs.

Once the merchant and user machines 18 and 20 are connected together, the user and an operator of the merchant machine 18 may interact together in a live video call. The operator may perform a live demonstration of the selected item and the user may ask questions about the selected item to the operator and receives answers from the operator.

At the end of the live demonstration, the user and/or the operator terminates the video call. The video call unit 60 may then transmit an interface to the user machine 20, which allows the user to rate the video call and/or the operator for example. Similarly, the video call unit 60 may transmits=an interface to the merchant machine 18, which allows the operator to rate the video call and/or the user for example.

In one embodiment, the system 50 may further comprise a purchase unit allowing the user to purchase the selected item or any other items from the merchant. In this case, the user is directed to the purchase unit 64 and may enter financial information to purchase the item. In another embodiment, the financial information may be already stored in the user account in the database 54 and retrieved by the purchase unit 64 therefrom. The user is then requested to confirm the purchase. In one embodiment, the user is requested to rate the operator before having the possibility to purchase the item. In another embodiment, the user rates the operator once the purchase of the item is completed.

The information about the video call such as the ratings performed by the user and the operator are stored in the database 54. If the user purchased an item, the purchase unit also stores the purchase information such as an identification of the purchased item and its price, in the database 54. The information stored in the database 54 may then be used by the analytics and statistics unit 62 for generating reports.

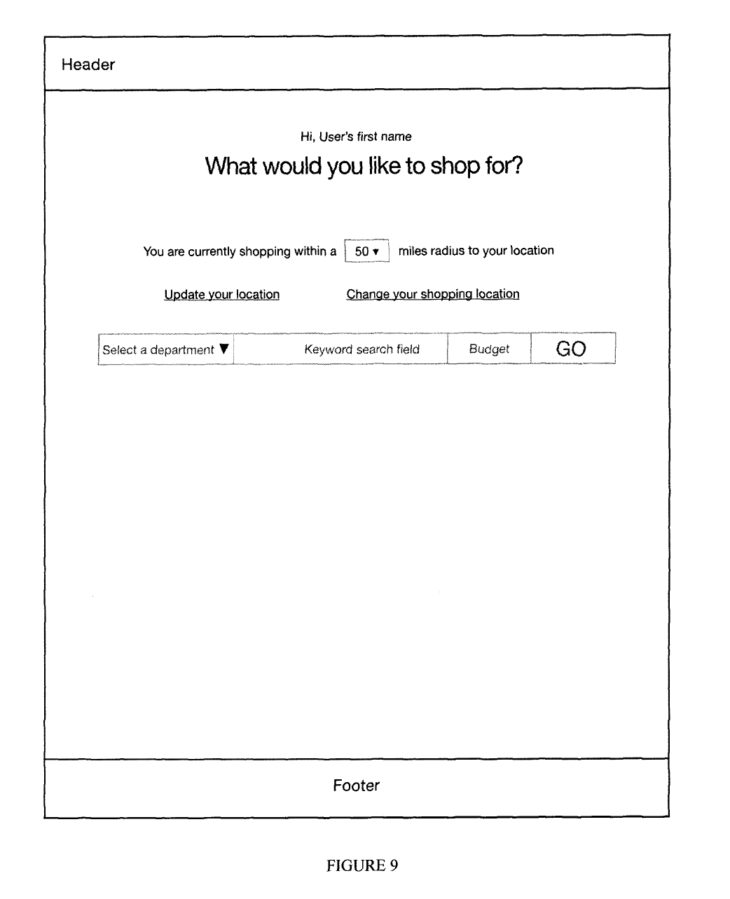

FIG. 8 illustrates one exemplary method followed by the search engine 56 to search for items queried by a user. As described above, the search engine 56 transmits an interface, such as the interface illustrated in FIG. 9, to the user machine 20. Via the interface, the user may enter at least one keyword corresponding to or defining a desired item. The user may also select a store department or item category corresponding to the desired item, and a budget for the desired item. The user may further restrict the search to a merchant located within a given distance from his location. In one embodiment, the search engine 56 uses the IP address of the user machine 20 which was determined during the initial registration of the user and stored in the database 54 in order to locate the user so that the user is not requested to enter his location. The user may update his location. In this case, the search engine 56 uses the actual IP address of the user machine 20 to locate the user. The user may also enter a specific shopping location which may be different from his actual location or this address.

Referring back to FIG. 8, the search keyword(s) and criteria are then transmitted by the user machine 20 to the search engine 56. The search engine 56 determines the items that match the search keyword(s) and criteria.

In an embodiment in which the database 54 comprises the list of items that the merchants offer for sale, the search engine 56 compares the search keyword(s) inputted by the user to the list of items contained in the database 54 in order to determine the items that match the query. The search engine may further restrict the search to items having a price comprised within the budget inputted by the user and items offered by merchants having a store located within the inputted given distance from the user location.

In another embodiment in which the database comprises no list of items available for sale originally inputted by the merchant when his account was created, the search engine 56 may be adapted to access the items offered by merchants and contained in the website of merchants, the POS of the merchants, and/or the inventory system of the merchants.

In an embodiment in which it is adapted to search in the website of the merchants, the search engine 56 is configured for using any adequate Internet bot methods, search bot methods, and/or website scrapping methods for navigating on the website of the merchants, identifying items on the website that match the query inputted by the user, and capture relevant information data about the identified items. The relevant information data may comprise the name, the price, the availability, the description, specifications, customer rating, and/or the like for the identified items and the name of the merchant offering the item for sale.

In the same or another embodiment, the search engine 56 is connected to the POS and/or inventory system of the merchants and uses the item information contained therein to determine the items that match the query inputted by the user. The search engine further retrieves the relevant information for the identified items from the POS and/or inventory system.

It should be understood that the search engine 56 may use more than one method for collecting information about the items available for sale in order to find items matching the item queried by the user. For example, the search engine may be connected to the POS and/or inventory systems of the merchants and further search on the website of the merchants.

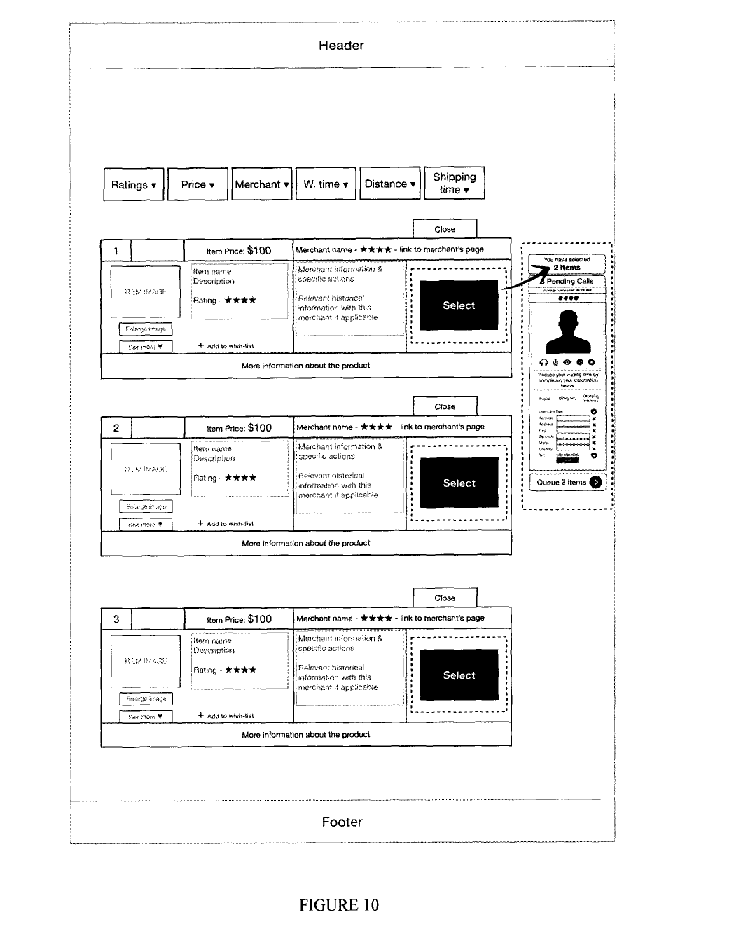

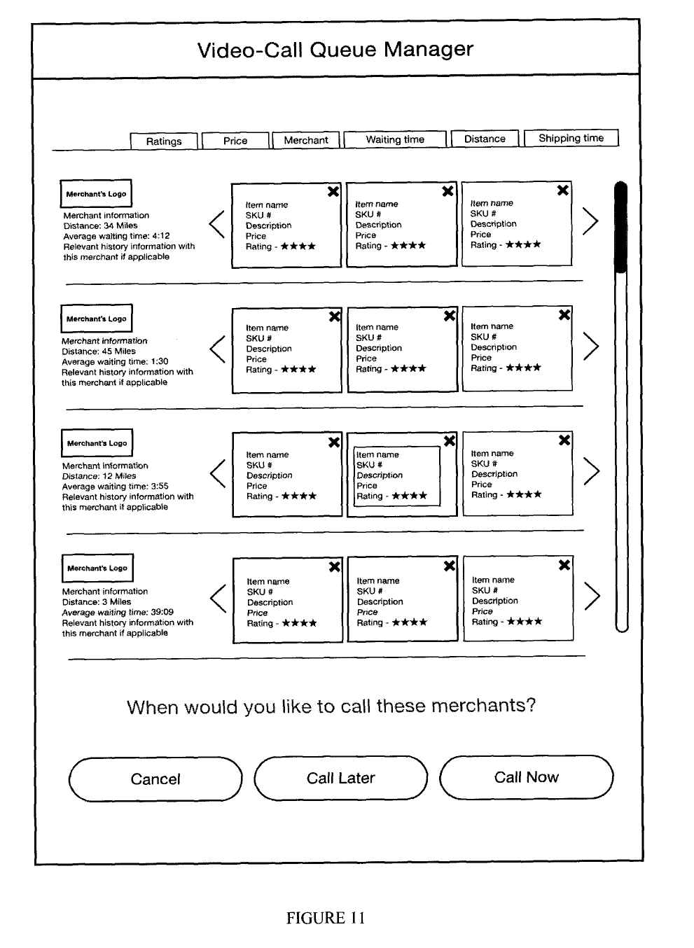

The search results, i.e. the items matching the user query and their relevant information, is transmitted by the search engine 56 to the user machine 20. The search results are then displayed on the display unit of the user machine 20. FIG. 10 illustrates one exemplary interface for presenting the search results to the user. Within the interface, the search results are ranked and may be displayed as a function of a parameter such as their price, their rating, the distance of the user from the store, the name of the merchant offering the item, an estimated shipping time provided by merchants when available, or the like. The search results may also be ranked as a function of a ranking of the merchants, as described below.

For each item comprised in the search results, the interface comprises information about the item and information about the merchant offering the item for sale. The information about the item may comprise a picture of the item in addition to the name, price, rating, availability, description, specifications, and/or the like. The information about the merchant may comprise the name and the rating of the merchant. Exemplary additional merchant information may comprise: the distance between the user location and the location of the merchant store(s), the address of the merchant, a description of the merchant, the logo of the merchant, a message from the merchant, a URL link towards the merchant website, etc.

In an embodiment, when more than one merchant offers for sale the item searched by the user, the search engine 56 is adapted to rank the merchants and display the items according to the ranking of the merchants. Several merchant attributes may be used by the search engine 56 for ranking the merchants. Such merchant attributes may comprise the availability of the merchant, attributes of the video call system of the merchants, attributes of compatibility between the merchant and user video call systems, attributes of historical data about the merchants, the merchant rating, and/or the like. A score is given to each merchant as a function of their attribute value using at least one predefined scoring rule. When at least two merchant attributes are used for ranking the merchants, a score is calculated for each merchant attribute. Weight factors may be applied to the merchant attributes and a total score for each merchant is determined by summing its corresponding weighted scores for the different merchant attributes. The merchants are then ranked according to their total score. The merchant having the greatest total score is assigned the first position and displayed at the top of the search results within the interface, the merchant having the second greatest score is then assigned the second position and displayed below the first merchant, the merchant having the third greatest score is assigned the third position and displayed below the second merchant, etc.

In one embodiment, the merchants are ranked as a function of at least their availability. The availability of a merchant may be indicated by the waiting time for the user to connect to the merchant via a video call. The waiting time is determined using any adequate method as described below. The shortest the waiting time is, the greatest the score assigned to the merchant is.

In one embodiment, the merchants are ranked as a function of at least historical data attributes such as historical video call performance, historical latency information, historical interaction between the user and the merchant, and/or the like. For example, the historical video call performance may include the number of calls dropped, the average call duration, the average bandwidth used, the average resolution obtained during a video call, and/or any other characteristic indicative of a potential technical problem. It should be understood that any adequate method for measuring the video call performances known in the art may be used. The historical latency information comprises information about the latency that occurred during previous video calls of the merchant. It should be understood that any adequate method for measuring the latency known in the art may be used. For example, the historical latency information may comprise the average latency for the video calls of the merchant, the best achieved latency, the worst achieved latency, and/or the like. A score is assigned to each merchant for at least one historical data attribute according to a set of predefined rules stored in the database 54. A rule may apply to historical interaction. For example, a first merchant who already interacted with the user in a video call may be assigned, by the video queueing unit 58, a score greater than that of another merchant who never interacted with the user.

It should be understood that the video call unit 60 is adapted to determine the historical video call performance and store them into the database 54. Similarly, the video call unit 60 is adapted to measure the latency occurring during video calls and store it in the database 54.

In one embodiment, the ranking of the merchants takes into account at least one attribute of compatibility between the user and merchant video call systems. A corresponding score is assigned to each merchant in order to indicate the compatibility between the merchant video call system and that of the user. A merchant/user video call system corresponds to the apparatus or system that will be used by the merchant/user to participate in the video call. For example, a video call system may comprise a tablet, a smartphone, a laptop, a system comprising a personal computer, a display unit, a camera, a microphone, and a speaker, and/or the like. The characteristics of a video call system comprise software and/or hardware characteristics, and may also comprise Internet connection characteristics. The software characteristics of the video call system may comprise the type and version of the operating system installed thereon, the type and version of the Internet browser installed thereon, the presence or absence of a firewall, the type and version of the firewall installed thereon, if any, and/or the like. The hardware characteristics of the video call system may comprise the type of the video call system such as a tablet, a smart phone, a laptop, or the like, the model of the video call system, the type or performance of processor installed thereon, the resolution of the display unit, the resolution of the camera, the presence or absence of a firewall, the type and version of the firewall installed thereon, and/or the like. The characteristics of the Internet connection may comprise the available bandwidth or rate of data transfer for the user, the IP location of the user, and/or the like.

In order to determine the compatibility between the merchant and user video call systems, at least one characteristic of the video call systems of the merchant and the same characteristic of the user video call system are determined and compared together, and a score is assigned to each merchant as a function of the result of the comparison. This score allows to measure the compatibility between the video call systems of the user and the merchant. The greater the compatibility between the merchant and user video call systems is, the greater the score assigned to the merchant is. The system 50 then comprises a module (not shown) adapted to investigate video call systems in order to determine at least one of the above-described attribute for the merchant video call system and the user video call system.

The score for the compatibility between the video call systems is determined according to a set of predefined rules stored in the database 54 or locally in a memory of the search engine 56. A rule may apply for determining the score for the compatibility of the operating systems. For example, the rule may provide a score for the compatibility between each possible merchant operating system and each possible user operating system. The rule may take the form of a table stored in the database 54. The score is then determined by accessing the table and retrieving the score corresponding to the merchant and user operating systems. In another example, the compatibility between the merchant operating system and the user operating system may further take into account the version of the operating systems. In this case, the table stored in the database 54 comprises a compatibility score for each possible combination of merchant operating system and version and user operating system and version. After determining the operating system and corresponding version for the user and merchant, the corresponding compatibility score is retrieved from the table stored in the database 54.

In one embodiment, a score is determined for each merchant for at least one of the attributes of their video call system according to a set of predefined rules. One rule may apply to the type of operating system. For example, a merchant provided with an Android™ operating system may be provided with a score greater than that assigned to a merchant provided with a Microsoft™ operating system. Another rule may apply to the version of the detected operating system. A greater score may be provided to a merchant having a newer version of operating system with respect to a merchant provided with an older version of the operating system. A further rule may apply to the presence/absence of a firewall. A merchant of which the video call system is provided with a firewall may be provided with a lower score than another merchant of which the video call system comprises no firewall For merchants of which the video call system comprises a firewall, another score may be assigned depending on the type of firewall, and a further score may be assigned to the users depending on the version of the firewall Another rule may apply to the type or performance of the processor of the video call system. For example, a greater score may be assigned to a first merchant of which the processor of the video call system is faster than the processor of the video call system of a second merchant. A further rule may apply to the resolution of the camera. For example, a first merchant may be assigned a score greater than that assigned to a second merchant if the resolution of the camera of the first merchant is greater than that of the second merchant. A still further rule may apply to the resolution of the display unit of the video call system. A first merchant may be assigned a score greater than that assigned to a second merchant if the resolution of the display unit of the first user is greater than that of the second merchant. Rules may apply for providing scores to the merchants for the attributes of their Internet connection. For example, a rule may apply to the available bandwidth for the merchants. For example, a merchant provided with a greater bandwidth than another merchant may be assigned a greater score for the bandwidth. Another rule may apply to the IP location of the merchants. For example, a score may be assigned to each merchant as a function of their IP location.

Once the results of the search are displayed, the user may then select an item for which he would like to place a video call with the corresponding merchant offering the selected item for sale. An identification of the selected item is sent from the user machine 20 to the search engine 56 which transmits the identification of the selected item to the video queueing unit 58 along with an identification of the user.

In one embodiment, the identified item and its relevant information which are retrieved from the merchant websites using web scrapping methods and/or the merchant POS and/or inventory systems are stored in the database 54. The search engine 56 then formats the retrieved data to present it in a standard format.

In one embodiment, the search engines 56 allows the user may to store the search results of a given search in his user account in the database 54.

The video queueing unit 58 is adapted to queue the different requests for video calls received from different users who requested a video call with a same merchant. The video queueing unit 58 transmits to the user machine 20 an interface in which the user may consult the items that he selected from the search results, as illustrated in FIG. 11. Through the interface of FIG. 11, the user may organize the displayed items as a function of criteria such as price, corresponding merchant, item rating, waiting time, shipping time, distance of the merchant location from the user location, etc.

For each item displayed in the interface of FIG. 11, item information such as an item identifier code, an item name, an item description, an item rating, an item price, an availability, and/or the like is displayed. For each item, merchant information about the merchant offering the item for sale is also displayed in the interface. The merchant information may comprise the name of the merchant, a description of the merchant, a distance between the user location and the merchant store location, an average waiting time for the video call, shopping history information, and/or the like. The shopping history information may comprise information concerning previous interactions between the user and the merchant such as a number of previous videos calls, a number of purchases made by the user at the merchant, etc.

Within the interface of FIG. 11, the user may place a video call for a specific item or a specific merchant. In one embodiment, the user has the option to contact the merchant as soon as the merchant is available (i.e. live video call). In the same or another embodiment, the user may schedule a video call with the merchant for a later time (i.e. scheduled video call).

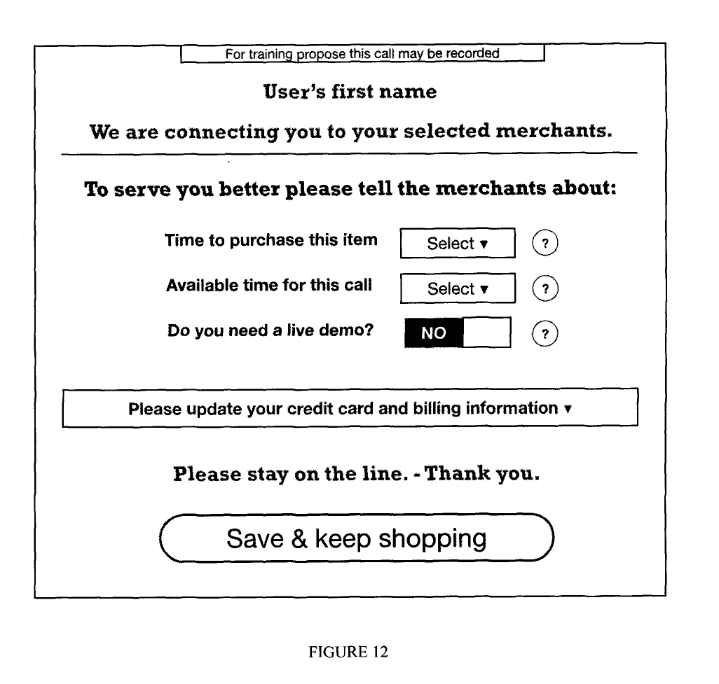

FIG. 12 illustrates one exemplary interface provided by the video queueing unit 58 to the user when the user has selected to connect in a video call with the selected merchant as soon as possible. The user is requested to provide some information such as a desired/expected time for purchasing the item, a time duration available for the live video call, whether he would like a live demonstration during the live video call, and/or the like. This information is then sent from the user machine 20 to the video queueing unit 58. The video queueing unit 58 then determines whether at least another user has requested a live video call with the same merchant to occur substantially at the same time. For example, if a user has requested a live video call to occur as soon as the merchant is available, the video queueing unit 58 determines whether at least another user has requested such a live video call with the same merchant. If yes, the video queueing unit 58 then ranks to users to determine a running order for the users to interact with the merchant. If a user has requested a scheduled video call with a merchant, the video queueing unit 58 may then determine whether at least another user has scheduled a video call with the same merchant substantially at the same date and time as the first user. If yes, the video queueing unit 58 may then rank the users to generate a running order for the users, and assign a scheduled date and time to each user as a function of the ranking of the users. The respective scheduled date and time is then sent to each user.

If no other user requested a live video call with the merchant, the video queueing unit 58 transmits a message indicating that a user is ready for a video call to the merchant machine 18. In one embodiment, the message may comprise information about the user who requested the video call and/or the item selected by the user. The information about the user may comprise the name of the user, the address of the user, the shopping history between the user and the merchant, the available time duration for the video call that was inputted by the user, and/or the like. The information about the selected item may comprise an identification of the selected item, the budget for the item inputted by the user, an indication as to whether the user requested a live demonstration of the item, an item category or department store, and/or the like. It should be understood that the video queueing unit 58 is adapted to retrieve the information to be included in the message, if any, from the database 54. If the merchant accepts the video call, the merchant machine 18 sends a message indicating that the merchant is ready for the video call. Upon reception of the merchant message, the video queueing unit 58 sends a confirmation message indicating that the merchant is ready for the video call to the user machine 20.

The video queueing unit 58 further indicates to the video call unit 60 that a video connection has to be created between the user and the merchant, as described below.

If at least another user has requested a live video call with the same given merchant, the video queueing unit 58 first determines the running order between the users for interacting with the given merchant.

In one embodiment, the video queueing unit 58 determines the running order as a function of the time at which the users have requested a video call with the merchant. For example, the running order may correspond to a “first-come, first-served” order.

It should be understood that the users may be queued according to any other adequate methods. The video queueing unit 58 may determine a value for at least one attribute for each user, and assign a score to each user as a function of the value of its respective attribute. For example, the position of a user within the queue may further be determined as a function of the type of account that the user has, the particular shopping history of the user with the merchant, the degree of completion of the user profile, the particular history of interactions of the user with the system 50, the rating of the user, and/or the like.

For example, a user having a premium account for which he pays monthly fees may be prioritized with respect to users who have a free user account. A first user having a rating higher than a second user may be prioritized with respect to the second user. A first user whose account/profile has a greater degree of completion than a second user may be prioritized with respect to the second user. For example, a user whose profile comprises credit card information may be prioritized with respect to a user who has no credit card information in the user profile stored in the database 54. The queueing between the users may also take into account their respective rating given by the merchants. For example, a first user having a rating greater than a second user may be prioritized with respect to the second user. In another example, the queueing between the users may be performed according to the value of the item selected by the users and for which they requested a video call with the merchant. For example, a first user who has selected an item that is more expensive than the item selected by a second user may be prioritized with respect to the second user.

As described above, the queueing of the users may also be made as a function of their past interactions with the given merchant with whom they requested a video call. In one embodiment, merchants may want to favor users with whom they never had any video calls with respect to other users. In this case, the video queueing unit 58 prioritizes such users. In this case, the video queueing unit 58 assigns to the user who never had any interactions with the merchant a score greater than that assigned to a user who already had interactions with the merchant. In another embodiment, the video queueing unit 58 prioritizes users who already had video calls with the given merchants with respect to the users who never had video calls with the merchant. For example, the queueing of the users may be performed as a function of the number of video calls they had with the merchant, the number of items they actually bought from the merchant, the total amount of money they spent during the video calls with the merchant, and/or the like.

In one embodiment, the queueing of the users may be performed as a function of their history with the system 50. The video queueing unit 58 may assign a queue position to the users as a function of one or more of the following criteria: number of user connections to the system 50, total number of video calls done using the system 50, amount of money spent using the system 50, social interactions, etc. The social interaction criteria may comprise the number of reviews that a user wrote about merchants, the number of video calls they saved in the database 54, the number of video calls that they shared with other users, the number of friends they invited to attend video calls, and/or the like.

It should be understood that the video queueing unit 58 retrieves all relevant information for evaluating the above-described attributes from the database 54. In one embodiment, the video queueing unit 58 assigns a score to each user as a function of a single one of the above-described attributes. In another embodiment in which more than one attribute is used for assigning a queue position to the users, the video queueing unit 58 determines a user score for each attribute and a weight factor may be assigned to each attribute. For each user, the video queueing unit 58 then determines a total score using the individual user score for each attribute and the weight factor assigned to the attribute. The queue position for the users is then determined as a function of their total score. It should be understood that the user obtaining the highest score is ranked first, the user obtaining the second highest score is ranked second, etc.

In one embodiment, the video queueing unit 58 is adapted to generate two different queues using the method described above, i.e. a first queue for users who requested a live demonstration of the item they selected, and a second queue for users who did not request a live demonstration. For example, a merchant may be provided with at least a first merchant machine 18 adapted for live demonstration and a second merchant machine that is not adequate for live demonstration. In this case, the video queueing unit 58 generates a first queue for first users who requested a live demonstration and a second queue for the other users.

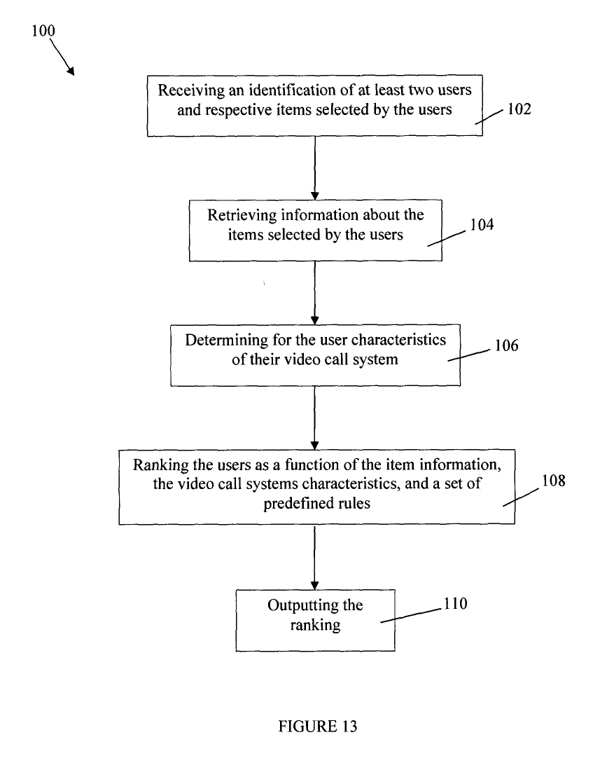

FIG. 13 illustrates a further method 100 for queueing users of the system 50 when at least two users request a video call with a same given merchant. The goal of the method 100 is to generate a running order of the users for interacting with the merchant via a video call. The first step 102 comprises receiving at least an identification of the users who requested a video call with the given merchant, and an identification of the respective items selected by the users for which they requested the video call. At step 104, relevant information about the items selected by the users is retrieved from the database 54. The relevant information about the item may comprise item attributes such as the Stock Keeping Unit (SKU) of the item, the model of the item, the color of the item, the price of the item, the availability of the item, the inventory, the shipping options associated with the item, the store pick-up options associated with the item, and/or the like.

At step 106, at least one characteristic or attribute of the video call system of each user is determined. A user video call system corresponds to the apparatus or system that will be used by the user to video connect to the merchant video call system. For example, a video call system may comprise a tablet, a smartphone, a laptop, a system comprising a personal computer, a display unit, a camera, a microphone, and a speaker, and/or the like. The attributes of a video call system comprise software and/or hardware attributes, and may also comprise Internet connection attributes. The software attributes of the video call system of the user may comprise the type and version of the operating system installed thereon, the type and version of the Internet browser installed thereon, the presence or absence of a firewall, the type and version of the firewall installed thereon, if any, and/or the like. The hardware attributes of the user video call system may comprise the type or performance of processor installed thereon, the resolution of the display unit, the resolution, type, and/or model of the camera, and/or the like. The attributes of the Internet connection may comprise the available bandwidth or rate of data transfer for the user, the IP location of the user, and/or the like.

In one embodiment, a live determination of the attributes of a video call system is performed. It should be understood that any adequate methods allowing a live determination of the attributes of a video call system may be used. For example, active and/or passive fingerprinting methods may be used for determining at least some attributes of a video call system.

In the following, exemplary fingerprinting techniques or methods adapted to determine attributes/characteristics of a video call system are presented. For example, an approximation of the browser type, and its version, may be determined form the user-agent header. The user-agent header may also be used for approximating the operating system type installed on the video call system and its version and, from there, the type of the device (e.g. smartphone, tablet, laptop, or the like) that runs the determined operating system. Native application programming interfaces (APIs) may be used to detect the type of camera and microphone contained in the video call system. The presence of a firewall may be determined using a session traversal utilities for NAT (STUN) method. The performance of a processor of a video call system may be determined by sending a test to be executed to the video call system. The faster the test is executed, the greater the performance of the processor is. The screen resolution may be determined using Javascript™ in browsers and using the native API on mobile devices. The video call system download rate may be measured by loading an image of a known size and measuring the time taken by the video call system to download the image. The video call system upload rate may be measured by using Javascript to submit a <form> element containing an <input> element which contains data with a known length, and measuring the time taken for the form submit to complete.

In another embodiment, all information about the video call systems of the merchants and users is stored in the database 54. For example, the users and merchants may upload to the database 54 information about their respective video call system(s) while creating their account for example. In this case, the attributes of the user video call system are then retrieved from the database 54 by the video queueing unit 58.

At step 108, the users having requested a video call with the given merchant are ranked as a function of the previously determined item information, the previously determined video call system attribute(s), and a set of predefined rules. In one embodiment, a predefined rule comprises an identification of an attribute to be evaluated, a comparison method/algorithm for evaluating the attribute for each user, and a scoring method/algorithm for scoring each user as a function of the evaluation of the attribute. In another embodiment, a predefined rule may correspond to a table comprising all possible values for an attribute and a corresponding score for each value. A score is given by the queueing unit 58 to each item attribute considered and to each video call system attribute considered, using the set of predefined rules. For example, the set of predefined rules, which is stored in the database 54, may comprise a corresponding score for each possible value for each item information attribute and for each video call system attribute. For example, a rule may apply to the type of item. The database 54 may comprise a list of items to be prioritized, and a corresponding score for each item to be prioritized. In this case, if it corresponds to an item comprised in the list of prioritized items, then an item selected by one of the users is provided with the corresponding score. If the item is not included in the list of prioritized items, then the selected item may be provided with a score equal to zero. The list of items to be prioritized may be uploaded by the merchant via the profile manager unit 52. Another rule may apply to the color of the selected item. A respective score may be stored in the database 54 for the different possible colors for an item. A further rule may apply to the price of an item and/or the profit margin. For example, the more expensive a selected item is, the higher score the item is provided with. Another rule may apply to the availability of the selected item. For example, an item being actually available may be provided with a score greater than an item that will only be available within a predetermined period of time, and an item that will only be available within a predetermined period of time may be assigned a score greater than an item that is not available and for which future availability is unknown. A further rule may apply to the shipping options of the selected item. For example, an item for which shipping is free may be provided with a score greater than that of another item for which shipping is payable. A still further rule may apply to the store pick-up options associated with an item. For example, an item for which store pick-up is possible may be provided with a score greater than that of another item for which store pick-up is not possible.

When the item information comprises at least two different item information attributes, a weight factor is applied to the individual scores provided to the different item information attributes. The summation of the at least two weighted scores corresponds to the total score for the item information. The summation is performed for each user so that each user is provided with a respective score for the information about the item that he selected.

If the item information comprises a single type of information, then the score assigned to this type of information corresponds to the score of the user for the item information.

The predefined set of rules further comprises rules for assigning a score to at least one attribute of the user video call system. For each user, a score for his video call system is calculated. One rule may apply to the type of operating system that runs on the computer system of the user. For example, a user provided with an Android™ operating system may be provided with a score greater than that assigned to a user provided with a Microsoft™ operating system. Another rule may apply to the version of the detected operating system. A greater score may be assigned to a user having a newer version of the operating system with respect to a user provided with an older version of the operating system. A further rule may apply to the presence/absence of a firewall. A user of which the video call machine is provided with a firewall may be provided with a lower score than a user of which the video call system comprises no firewall. For users of which the video call system comprises a firewall, another score may be assigned depending on the type of firewall, and a further score may be assigned to the users depending on the version of the firewall. Another rule may apply to the type or performance of the processor of the video call system. For example, a greater score may be assigned to a first user of which the processor of the video call system is faster than the processor of the video call system of a second user. A further rule may apply to the resolution of the camera. For example, a first user may be assigned a score greater than that assigned to a second user if the resolution of the camera of the first user is greater than that of the second user. A still further rule may apply to the resolution of the display unit of the video call system. A first user may be assigned a score greater than that assigned to a second user if the resolution of the display unit of the first user is greater than that of the second user. Other rules may apply for providing scores to the users according to the attributes/characteristics of their Internet connection. For example, a rule may apply to the available bandwidth for the users. For example, a user provided with a greater bandwidth than another user may be assigned a greater score for the bandwidth. Another rule may apply to the IP location of the users. For example, a score may be assigned to each user as a function of their IP location.

When the attributes of the video call system comprise at least two different attributes/characteristics, a weight factor is applied to the individual scores provided to the at least two different attributes. The summation of the at least two individual weighted scores corresponds to the total score for the attributes of the video call system. The summation is performed for each user so that each user is provided with a respective score for his video call system.

If only a single characteristic of the video call system is considered, then the score assigned to the single characteristic corresponds to the score of the user for his video call system.

Once a score for the item attributes and a score for the video call system attributes have been calculated for each user who have requested a video call with the given merchant, a total score is calculated for each user. A weight factor is applied to the score for the item attributes and the score for the video call system attributes, and the total score for each user corresponds to the sum of their respective weighted scores for the item attributes and the video call system attributes. The users are then ranked as a function of their total score and the user having the greatest score is assigned the first position in the queue for interacting with the merchant.

The running order, i.e. the position of the users in the queue, is then outputted. For example, the running order may be stored in memory. In another example, the running order may be sent to the video call unit 60 which will connect the users to the merchant as a function of the running order.

In one embodiment, the method 100 further comprises determining at least one user attribute retrieved from the user information stored in the database 54 and assigning a score to the user according to the determined user attributes. The user attributes information is retrieved from the database 54. The user attributes may comprise the language of the user, the user purchase history, the video call history, the user location, the user rating, credit card information, the time zone of the user, the user video call experience, and/or the like. A score for each one of the considered user attributes may be assigned to each user. In this case, a predefined set of rules is used for assigning the score to each attribute. For example, a rule may apply to the language so that the user be scored as a function of his language. For example, an Anglophone user may receive a higher score than a Francophone user. In this case, it should be understood that the system is then adapted to connect the user to an operator of the merchant who speaks the same language as the user. A rule may apply to the user purchase history. For example, a score may be assigned to users as a function of the number of purchases they already made using the system 50, the total amount of money for the total number of purchases they already made using the system 50, and/or the like. The score may increase with the number of purchases, the total amount of money spent via the system 50, and/or the like. Another rule may apply to the video call history. For example, a score may be assigned to the users as a function of the number of video calls that they previously performed with merchants while using the system 50. The score may increase with the number of previous video calls. A further rule may apply to the location of the user. The location of a user may be represented by the complete user address stored in the database 54, the user zip code, the user city, the user state or province, the user time zone, or the like. For example, a score may be assigned to the users as a function of their location. For example, the closer the location of a user is from the location of the merchant, the higher the score assigned to the user is. In another example, users living in a large or medium size city may be provided with a score greater than that assigned to users of which the location corresponds to a small city or a village. Another rule may apply to the rating of the users. For example, the greater the rating of a user is, the greater the score assigned to the user is. A further rule may apply to the user credit card information. For example, a user of which the credit card information is stored in the database 54 may be provided with a score greater than that assigned to a user who has not registered his credit card information in the database 54. In another example, the score may depend on the type of the credit card of the users. Another rule may apply to the time at which the video call is placed. A score may be assigned to each user depending on the local time at which the user requests the video call with the given merchant. A further rule may apply to the video calls experience of a user. The more experienced a user is with respect to video calling, the greater the score assigned to the user is. The experience of a user relative to video calls may be represented by the number of accounts to video call platforms, such as Skype™, Google Hangouts™, and/or the like, that the user has. In this case, the information about the user accounts to video call platforms is stored in the user profile. For the example, if a first user has registered an account to a video call platform in his profile and a second user has no such account, then the first user is assigned a score greater than that assigned to the second user.

In one embodiment, a score is assigned to more than one user attribute. In this case, a weight factor may be assigned to each user attribute, and the total score of a user for his user attributes corresponds to the sum of all of the weighted scores for the considered user attributes.

In another embodiment in which a single user attribute is considered, then the score assigned to the single considered user attribute corresponds to the total score for the user attributes.

The score for the user attributes is then used with the score for the item attributes and the score for the video call system attributes for calculating the total score for the user. Weight factors may be assigned to each score for calculating the total score.

In one embodiment, the ranking of the users performed at step 108 of the method 100 takes into account business factors. In this case, a score is assigned to each user having requested a video call with the given merchant according to at least one business factor. Examples of business factors comprise the average revenue per call for the item selected by a user, the average revenue per call for the location of a user, the actual time of the day in the user time zone, and/or the like. A score is calculated for at least one business factor using predefined rules. A rule may apply for determining the score for the average revenue per call for the items selected by the users. For each item selected by a user, the corresponding average revenue per call is retrieved from the database 54, and a score is assigned to each user as a function of the average revenue per call for the item that the user selected. For example, the greater the average revenue per call for the item is, the greater the score is. Another rule may apply for determining a score for the average revenue per call for the location of the user. The database 54 comprises a value of average revenue per call as a function of locations. For each user, the average revenue per call for the user location is retrieved from the database 54 and a score is assigned to each user as a function of the retrieved average revenue per call for the user location. For example, the greater the average revenue per call for the user location is, the greater the score assigned to the user is. A further rule may apply to the day of the week and/or the actual time of the day in the user time zone. For example, a score may be assigned to the user as a function of the user actual time of the day within his time zone. For example, a user located on the West coast of the US and a user located on the East coast may both request a video call with a same merchant located on the West coast at a given time corresponding to the afternoon for the West coast user and the evening for the East coast user. Statistics data stored in the database 54 may be indicative that, for the merchant, the chances to conclude a sale are greater in the evening than in the afternoon. In this case, the East coast user is assigned a greater score than the West coast user. In one embodiment, a score is assigned to more than one business attribute. In this case, a weight factor may be assigned to each business attribute, and the total score of a user for his business attributes corresponds to the sum of all of the weighted scores for the considered business attributes.

In another embodiment in which a single business attribute is considered, then the score assigned to the single considered business attribute corresponds to the total score for the business attributes.

The score for the business attributes is then used with the score for the item attributes, the score for the video call system attributes, and the score for the user attributes, if any, for calculating the total score for the user. Weight factors may be assigned to each score for calculating the total score.

In one embodiment, the ranking of the users performed at step 108 of the method 100 further takes into account at least one attribute of the compatibility between the merchant video call system and the users video call system. For each user having requested a video call with the same merchant, a score for at least one compatibility attribute is calculated. This score allows to measure the compatibility between the video call systems of the user and the merchant. The greater the compatibility between the merchant and user video call systems is, the greater the score assigned to the user is. Examples of compatibility attributes comprise the type of operating system, the version of the operating system, camera characteristics such as the resolution, and/or the like. In this case, the method 100 further comprises a step of determining the attributes/characteristics of the merchant video call system. A score is calculated for at least one compatibility attribute using at least one predefined rule. A rule may apply for determining the score for the operating system compatibility. For example, the rule may provide a score for the compatibility between each possible merchant operating system and each possible user operating system. The rule may take the form of a table stored in the database 54. The score is then determined by accessing the table and retrieving the score corresponding to the merchant and user operating systems. In another example, the compatibility between the merchant operating system and the user operating system may further takes into account the version of the operating systems. In this case, the table stored in the database 54 comprises a compatibility score for each possible combination of merchant operating system and version and user operating system and version. After determining the operating system and corresponding version for the user and merchant, the corresponding compatibility score is retrieved from the table stored in the database 54. Another rule may apply to the compatibility of the cameras of the user and merchant. For example, characteristics of the user and merchant cameras such as the brand, the model, the maximum resolution, the video protocols supported by the camera, and/or the like are compared and a score is assigned to the users according to the results of the comparison.

In one embodiment, a compatibility score is assigned to more than one merchant video call system attribute. In this case, a weight factor may be assigned to each merchant video call system attribute, and the total compatibility score for a user corresponds to the sum of all of the weighted compatibility scores.

In another embodiment in which a single merchant video call system attribute is considered, then the compatibility score assigned to the single considered attribute corresponds to the total score for the compatibility between the user and merchant video call systems.

The score for the compatibility between the user and merchant video call systems is then used with the score for the item attributes, the score for the video call system attributes, the score for the user attributes, if any, and the score for the business attributes, if any, for calculating the total score for the user. Weight factors may be assigned to each score for calculating the total score.

Once the total score has been calculated for each user having requested a video call with the same given merchant, the ranking of the users is performed using the determined user total scores. The user having the greatest total score is assigned the first position in the queue, the user having the second greatest total score is assigned the second position in the queue, etc.

It should be understood that the method 100 may be combined with any other above-described method for queueing users having requested a video call with a same merchant. For example, the method 100 may further take into account the type of account of the users. A weighted score may be assigned to the users as a function of their type of account, as described above, and the total score assigned to the users takes into account the weighted score for the type of account.

In one embodiment, the user schedules a video call with a given merchant at a predetermined date and time. In this case, the user selects a given date and time for the video call with the given merchant. The queueing unit then determines whether at least another user requested a video call with the same merchant at the same date and substantially the same time. If so, the queueing unit then ranks the user using one of the above-described queueing method such as method 100 for example. The ranking is stored in memory and a start time for the scheduled video call for each user is determined and provided to the users.

In one embodiment, when he connects to the platform at the date and time previously determined, no further user ranking is performed and the user who scheduled the video call is connected to the given merchant via a video connection.

In another embodiment, a further ranking is performed when the user connects to the platform at the given date and time. For example, the given user who scheduled the video call and other users who request a live video call with the same merchant are ranked before connecting the given user to the merchant.

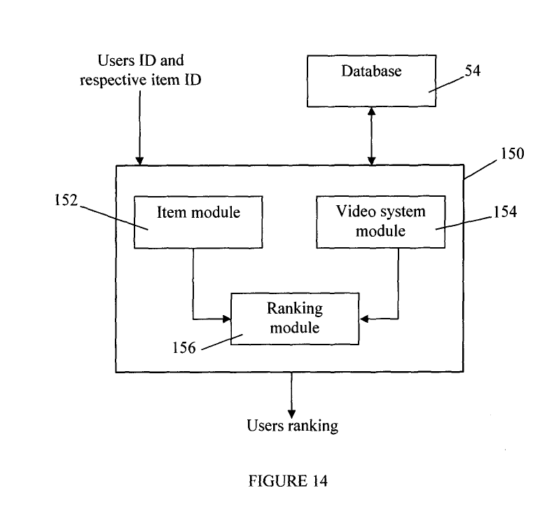

FIG. 14 illustrates one embodiment of a video queueing unit 150 adapted to perform the queueing method 100. The video queueing unit 150 comprises an item module 152, a video system module 154, and a scoring module 156. The video queueing unit 150 receives an identification of the users who requested a video call with the same given merchant, and an identification of the item for which each user has requested the video call. The video queueing unit 150 is further connected to the database 54 to retrieve information contained therein. The video queueing unit 150 is adapted to execute the above-described method 100 in order to output a ranking of the users.

The item module 152 is adapted to receive the item identification for each user, retrieve, from the database 54, at least a same attribute for each item, and apply at least one predefined rule to determine a score for each user. The predefined rule may be stored locally in the item module 152 or in the video queueing unit 150, or in the database 54. The item module 152 identifies the item attribute to be evaluated from the predefined rule, retrieves the attribute for each item from the database 54, evaluates and scores the attribute for each user according to the predefined rule, as described above. The score for the item assigned by the item module 152 is then transmitted to the scoring module 156.

The video system module 154 is adapted to receive an identification for each user having requested a video call with the given merchant, determine at least one attribute for the video call system of each user, and assign a score to the video call system of each user. The video system module 156 is adapted to retrieve a predefined rule which is indicative of the attribute to be evaluated. The video system module 156 then determines the attribute to be evaluated from the retrieved rule and then determines an attribute value for the video call system of each user. The score for the video call system assigned by the module 154 is then transmitted to the scoring module 156.

Upon reception of the score for the item and the score of the video call system for each user, the scoring module 156 determines a total score for each user, as described above. Using the total score assigned to each user, the scoring module 156 then ranks the user as a function of their respective score, the user having the greatest score being ranked first. The scoring module 156 then outputs the users ranking. For example, the user ranking may be stored in memory or sent to the video call unit 60.

In one embodiment, the video queueing unit 150 further comprises a user unit adapted to determine at least one user attribute for each user, and assign a score to each user for the user attribute, as described above. The scoring unit 156 further takes into account the score for the user attribute in order to determine the total score for each user.

In one embodiment, the video queueing unit 150 further comprises a business unit adapted to determine at least one business attribute for user, and assign a score to each user for the business attribute, as described above. The scoring unit 156 further takes into account the score for the business attribute in order to determine the total score for each user.

In one embodiment, the video queueing unit 150 further comprises a video system comparison unit adapted to determine at least one compatibility attribute between the merchant video call system and the video call systems of the users, and assign a score to each user for the compatibility attribute, as described above. The scoring unit 156 further takes into account the score for the compatibility attribute in order to determine the total score for each user.

In one embodiment, the video queueing unit 58 is further adapted to determine, for each user in the queue, an average waiting time for interacting with the merchant. For a given user, the estimated average waiting time is calculated using an estimated video call duration for each user located before the given user in the queue, an average response time for the merchant to respond to a video call, and an estimated remaining time if a user is presently in a video call with the merchant.

In one embodiment, for a given user, the estimated time duration for a video call is determined using factors such as a user average duration which is calculated using the time durations of the previous video calls made by the given user, a merchant average duration which is calculated using the previous video calls made by the merchant, and the estimated time duration for the video call entered by the given user while requesting the video call.

In another embodiment, the estimated time duration is determined from the median call duration for the user which is determined using the previous video calls done by the user (median 1), the median call duration for the selected item which is determined using the previous calls done for the item by all users who selected this item (median 2), the median call duration for identical users using the previous calls done by all the identical users (median 3), the median call duration for the merchant using all of the previous calls done by the merchant (median 4), the median call duration for the selected item which is determined using the previous calls done for the item by the merchant (median 5), and the median call duration for the particular operator of the merchant who will answer the video call (median 6). The estimated time duration is then obtained as follows: (median 1+median 2+median 3+median 4+median 5+median 6)/6. It should be understood that identical users correspond to users having a common attribute such as a same operating version, a same profile characteristic, a same location, and/or the like.

In one embodiment, the video queueing unit 58 determines the average waiting time only for the items selected by the user. In another embodiment, it determines the average waiting time for all of the items of the search results and the average time is displayed in the search result interface.

In one embodiment, the estimated waiting time for the items comprised in the search results is calculated by the video queueing unit 58 before the search results are transmitted to the user machine 20. In this case, the estimated waiting time may be displayed for each item within the interface and the search results may also be ranked and displayed as a function of their respective estimated waiting time.

When a user is at the first position in the queue and a previous user terminates a video call with the merchant, the video queueing unit 58 transmits a message indicating that a further user is ready for a video call to the merchant machine 18. In one embodiment, the message may comprise information about the user who requested the video call and/or the item selected by the user. The information about the user may comprise the name of the user, the address of the user, a distance between the merchant location and the user location, the history between the user and the merchant, the available time duration for the video call that was inputted by the user, and/or the like. The information about the selected item may comprise an identification of the selected item, the budget for the item inputted by the user, an indication as to whether the user requested a live demonstration of the item, and/or the like. If the merchant accepts the video call, the merchant machine 18 sends a message indicating that the merchant is ready for the video call. Upon reception of the merchant message, the video queueing unit 58 sends a confirmation message indicating that the merchant is ready for the video call to the user machine. The video queueing unit 58 further indicates to the video call unit 60 that a video call has to be created between the user and the merchant, as described below.

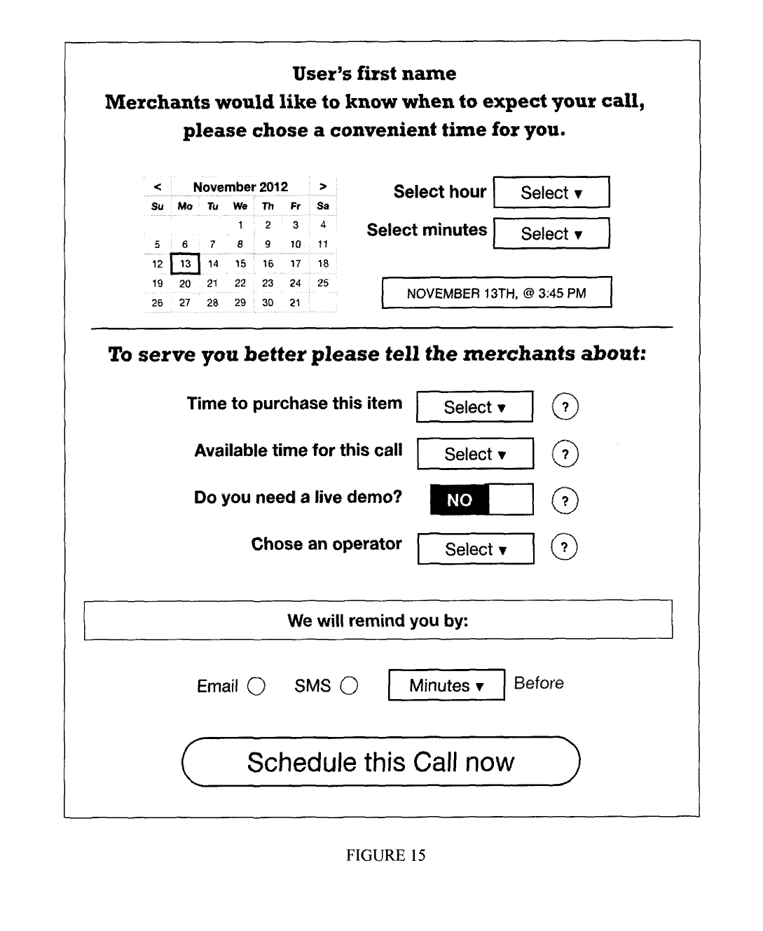

Referring back to FIG. 11, the user may also schedule a video call. FIG. 15 illustrates one exemplary interface generated by the video queueing unit 58 and sent to the user machine 20 in order for the user to schedule a video call with a selected merchant. The user is requested to provide some information such as a desired date and time for the video call, an expected/desired time to purchase the item, a time duration available for the video call, an indication as to whether he would like a live demonstration for the item during the video call or whether he would only interact with the merchant without any live demonstration, and/or the like. The user may also indicate whether he would like a reminder to be sent to him, the type of reminder such as email or SMS message, and the time at which the reminder should be sent by the system 50. The user may further select a desired merchant operator for the video call. This information is then sent from the user machine 20 to the video queueing unit 58.

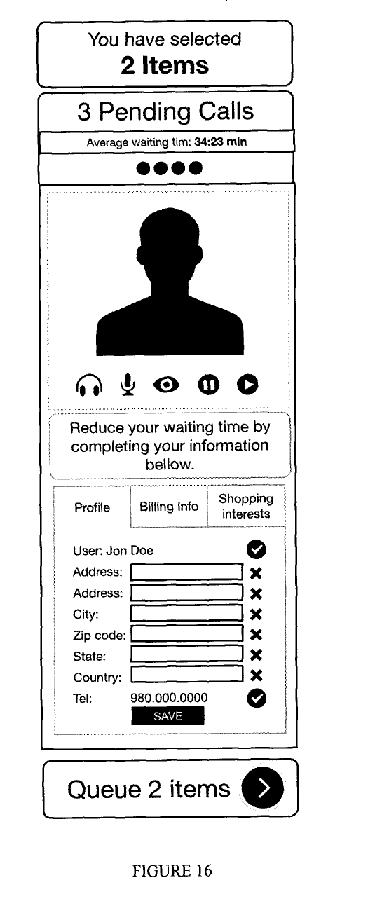

Referring back to FIG. 10, the search result interface may also comprise a video call panel which is generated by the search engine. The video call panel indicates the number of items selected for a video call by the user and the number of pending video calls, i.e. the number of video calls that the user has already placed and that are queued, as illustrated in FIG. 16. Furthermore, the video call panel may have a first box in which the user may enter user information such as his name, his address, his contact information, etc. A second box may allow the user to enter financial information such as credit card information, and a third box may allow the user to enter his shopping preferences. If the user information, the financial information and the interest information are already stored in the user account, the search engine automatically populates the information boxes using the information stored in the database 54, and the user is not requested to enter this information in the video call panel.

Once the merchant is ready for the video call and has accepted the video call, the video queueing unit 58 transmits to the video call unit 60 an identification of the user and an identification of the merchant or an identification of the merchant machine if the merchant has more than one merchant machine connected to the system 50. The video call unit 60 then creates a video connection between the user machine 20 and the merchant machine 18. In one embodiment, the video call unit 60 retrieves the IP addresses of the user machine 18 and the merchant machine 20 in order to connect them. It should be understood that any adequate method for creating a video connection between the user machine 20 and the merchant machine 18 may be used.

Once the user and the merchant are connected together, they may interact together. In one embodiment, the merchant operator provides the user with a live demonstration of the selected item and/or any other item that interests the user.

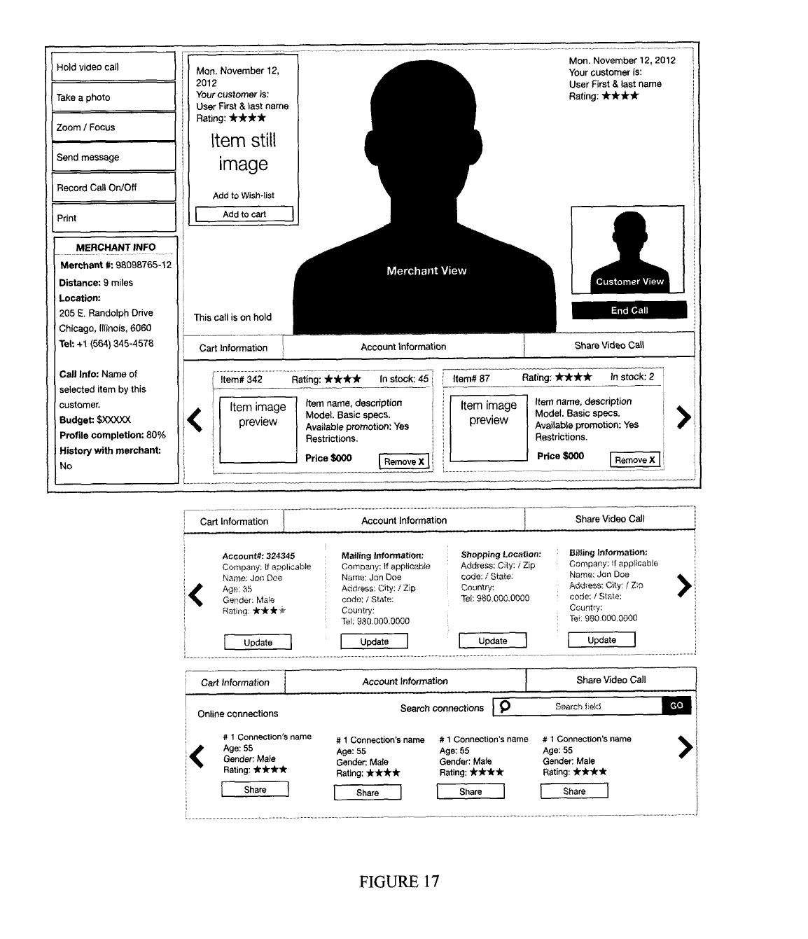

FIG. 17 illustrates one exemplary video call user interface generated by the video call unit 60 and transmitted to the user machine 20 to be displayed on the user display unit. The user interface comprises a control panel section, a general information section, a video section, and a shopping panel section.

The control panel section provides different functionalities to the user. For example, the user may control his camera in order to zoom in, zoom out, take a picture, record the video call, hold the video call, and/or the like. Via the control panel, the user may also send a message to the merchant with whom he has the video call, or to another user for example.

The general information section may display merchant information such as the name of the merchant, the distance of the user from the merchant, the location address of the merchant, the phone number of the merchant, and/or the like. The general information section may also comprise information about the item such as the name of the item and the price of the item, the budget for the item previously inputted by the user, the degree of completion of the user profile, the history between the user and the merchant, etc.

The video section displays the images that are captured by the merchant camera and transmitted by the video call unit 60. The video section may also comprise a section in which the images captured by the user camera, if any, are displayed. Furthermore, an item section comprising information about the item previously selected by the user and for which he requested the video call with the merchant may be inserted within the video section. Alternatively, the item information may correspond to information about an item other than the item selected by the user. For example, the item information may be about an item searched by the merchant during the video call as described below. The item information may comprise the name of the item, the price of the item, a picture of the item, the availability of the item, the rating of the object, specifications for the item, and/or the like. The item section may also provide some functionalities for the user such as: adding the item to the user wish-list, adding the item to the user shopping cart, requesting a brochure of the item, requesting to be informed of promotional offers for the item, and/or the like.

Via the shopping panel section, the user may consult his shopping cart, access and modify some of his account information, and invite a connection to share his video call. Each time the user selects an item displayed in the item section, this item is added to the user cart. Via the user cart section, the user may consult the item added to the cart, i.e. the item he would like to purchase. It should be understood that the user may delete items from the user cart. Via the shopping panel section, the user may access and update information such as user information, mailing information, shopping location information, and billing information for example. The user may input a mailing address, a shopping location address, a billing address, etc. Via the shopping panel section, the user may also search for a connection with whom he would like to share the actual video call. The user may search for a particular connection or consult the connections stored in his user account and invite a connection who is online to participate in the video call with the merchant.

In one embodiment, the invited connection may only look at the video captured by the merchant and hear the discussion between the user and the merchant without being able to talk to the merchant and the user. In another embodiment, the connection is provided with the same functionalities as the user and he may talk to the user and the merchant.

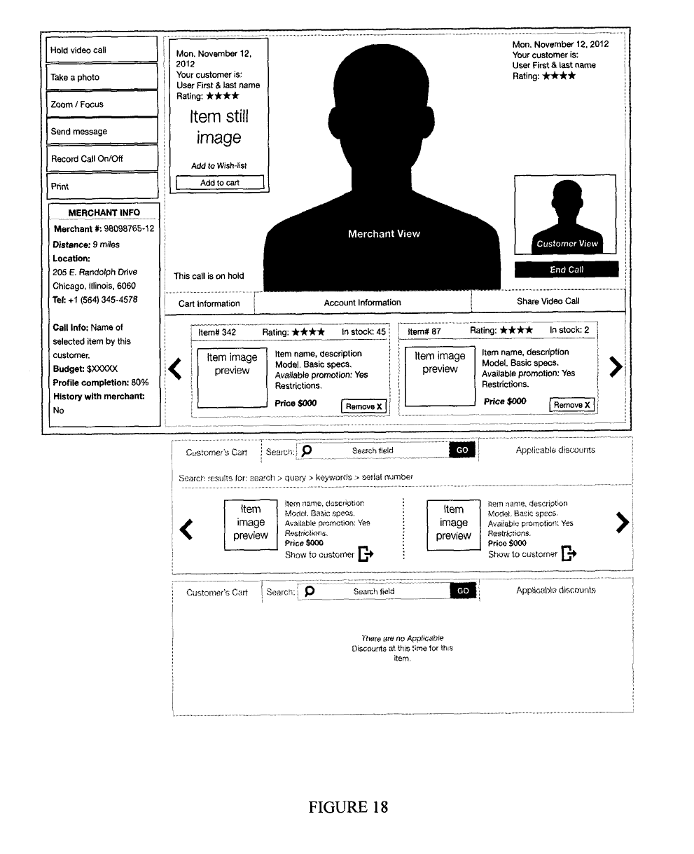

FIG. 18 illustrates one exemplary merchant interface generated by the video call unit 60 and transmitted to the merchant machine 18 to be displayed on the merchant display unit. The merchant interface comprises a control panel section, a general information section, a video section, and a shopping panel section.

The control panel section provides the merchant operator with different functionalities. For example, the merchant may take a picture and add it to the inventory, record the video call, transfer the video call to another operator, schedule a video call with the user, take notes, hold the video call, and/or the like. Using the printer integrated to the merchant machine, the operator can for example print stickers to mark items as reserved by a user or to be put aside for delivery. The operator can also use the barcode scanner integrated to the merchant machine to scan items to send product specifications to the user directly to the user machine interface.

The general information section may comprise information about the user and information about the actual video call. The information about the user may comprise user identification information such as a user ID and/or name of the user, the user location, an indication as to whether the user has already inputted credit card information, the date at which the user became a member of the system 50, and/or the like. The information about the video call may comprise an identification of the item for which the user requested the video call, the budget for the item inputted by the user, the degree of completion of the user profile, the history between the user and the merchant, the name of the last merchant operator with whom the user has had a video call, and/or the like.

The video section displays the images that are captured by the user camera and transmitted by the video call unit 60. The video section may also comprise a section in which the images captured by the merchant camera are displayed. Furthermore, an item section comprising information about the same item for which information is displayed in the item section of the user interface may be inserted within the video section. The item information may comprise the name of the item, the price of the item, a picture of the item, the availability of the item, the rating of the object, specifications for the item, and/or the like. The item section may also provide some functionalities for the merchant such as: sending a brochure of the item to the user, sending a promotional offer for the item to the user, and/or the like.

Via the shopping panel section, the merchant operator may see in substantially real-time the items that the user added to his user cart. The merchant operator may also search for items in the shopping panel section. The search query is then sent from the merchant machine 18 to the video call unit 60 and further transmitted to the search engine 56 that retrieves the item(s) corresponding to the search. The search engine 56 transmits the search results to the video call unit 60 which transmits them to the merchant machine 18. The merchant machine 18 displays the search results in the shopping panel section. The merchant operator may then select a given item from the search results. An identification of the selected item is then sent to the video call unit 60 which retrieves relevant information about the selected information from the database 54 or via the search engine 56. The video call unit 60 then displays the relevant information about the item selected by the merchant operator in the item section of the user interface and in the item section of the merchant interface. The user may then add this item to his user cart. The operator of the merchant might be allowed to give the user some discounts or rebates during a live interactive video call by simply pushing a button from the interface.

In one embodiment, during the video call with the merchant, the user may point and click on an item captured by the merchant camera. The item is then sent to the user cart. The user can control the focus and the zoom of the camera of the merchant and thus may also take pictures of items of interest in order to refer to those items in future communications with the merchant or other users of the system 50, for example.

It should be understood that the information contained in the user interface and the merchant interface are either retrieved by the video call unit 60 from the database 54 or received by the video call unit 60 from the video queueing unit 58 or the search engine 56.

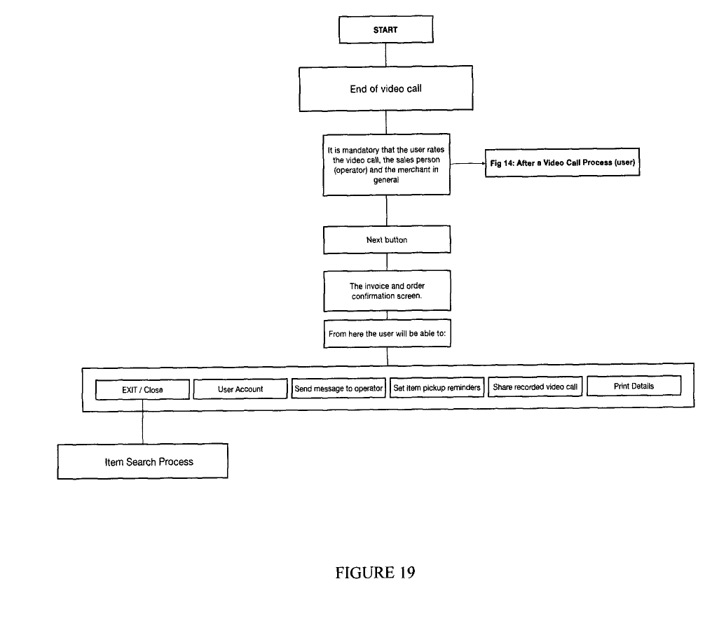

At the end of the video call, the user and/or the merchant operator terminates the video call. FIG. 19 illustrates the process followed by the user after the video call terminates. The video call unit 60 requests the user to rate the video call, the merchant operator, and/or the merchant. The video call unit 60 then transmits the information about the items placed in the user cart by the user and the account information to the purchase unit 64.

The purchase unit 64 generates a purchase interface and transmits the purchase interface to the user machine 20. For each item previously placed in the user cart by the user, the purchase interface comprises information such as the name of the item, the price of the item, a picture of the item, and/or the like. The purchase interface further comprises financial information such as credit card information, a billing address, a delivery address, and/or the like. The user may then review the transaction information displayed in the purchase interface and confirm the transaction. Upon confirmation of the transaction by the user, the purchase unit 64 sends the transaction information to a transaction server and provides the user with a confirmation of the transaction. The transaction is further recorded in the database 54.

The user may then have access to his user account, send a message to the merchant operator with whom he had the video call, set a reminder for an item pickup, if any, share the video call he had with the merchant, etc.

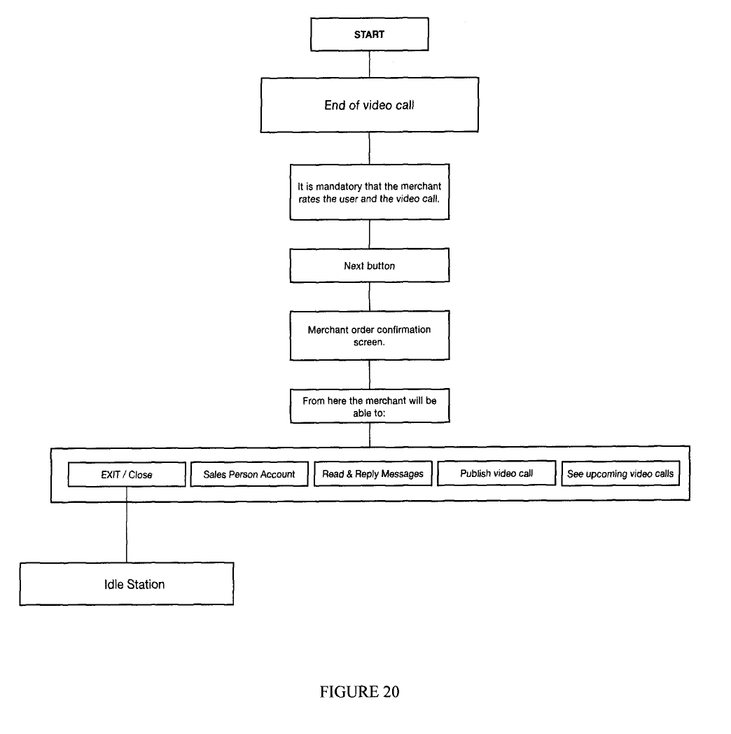

FIG. 20 illustrates one embodiment of a process followed by the merchant operator after the video call. The video call unit 60 requests the merchant operator to rate the video call and/or the user. Then the merchant operator may access his account, read and reply to messages from users, publish recorded video calls with the consent of the users, and be informed about incoming calls and accept those incoming video calls, etc.

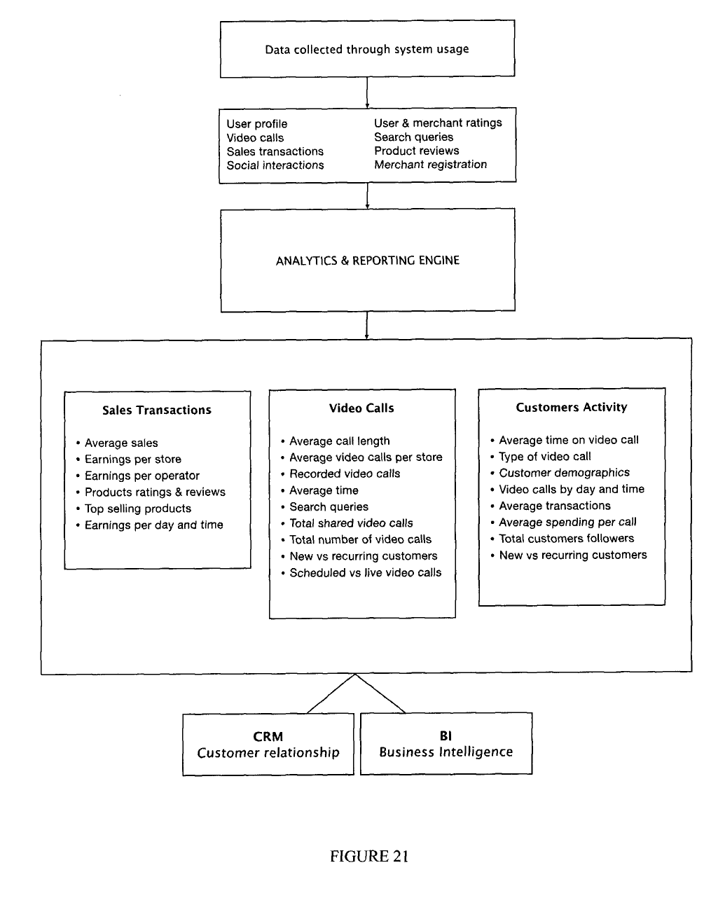

FIG. 21 illustrates exemplary functionalities of the analytics and statistics engine 62. It should be understood that the data generated during the operation of the system 50 is stored in the database 54. The analytics and statistics engine 62 retrieves the data from the database, analyzes the data, and generates reports that may be accessed by merchants and/or users. Examples of data collected during the operation of the system 50 and stored in the database 54 comprise user profile information, information about video calls, information about the sales transactions, information about the social interactions, user and merchant ratings, information about the search queries done by the users, the reviews made by the users, the registration of the merchants, etc.

Using the data stored in the database 54, the analytics and statistics engine 62 may generate sales transactions statistics, video calls statistics, and customers activity statistics for example. The sales transactions statistics may comprise, for each merchant, a sales average, earnings per store, earnings per operator, item ratings and reviews, top selling items, earnings per day and time, and/or the like. The video calls statistics may comprise an average call duration for a given user, an average call duration for a given merchant operator, an average video call duration for a given merchant, the number of video calls per store for a given merchant, the number of recorded video calls for a given merchant, an average waiting time, the search queries, the number of video calls with a given merchant that were shared by users, the number of video calls performed per operator or store, the total number of video calls for a merchant, the number of new customers, the number of recurring customers, the number of video calls that were previously scheduled, the number of live video calls (i.e. the number of video calls that were not previously scheduled), etc. The customers activity statistics may comprise a user average video call duration, the number of scheduled video calls, the number of live video calls, customer demographics data, the number of video calls per day and time, an average number of transactions, an average spending amount per video call, a number of customer followers, and/or the like. In one embodiment, some or all of those statistics are available to the merchant administrator.

Referring back to the method and system 100 and 150 for queueing users, it should be understood that the queueing method 100 and the queueing system 150 may be used in the context of users requesting a video call for a service. In this case, the term “item” should be understood as being a service. For example, users may connect to the website of a telecommunications company and select a service call to solve a given problem. In this case, the item information may comprise the type of service requested such as a service for a cellular phone problem, a service for a television cable problem, a service for a residential phone problem, a service for an Internet connection problem, or the like. The queueing of the users is then performed as a function of at least one attribute of the service requested by the users, such as the type of service requested, and at least one attribute of the video call system of the users.

In another example, the service is an expertise offered for sale by an expert or service provider. In this case, the queueing of the users requesting a video call with a same service provider is performed as a function of service information such as the type of service requested by the users, and at least one attribute of the user video call system.

It should be understood that the above described systems 10 and 50 may be each embodied in a system comprising at least one processing unit, at least one memory or data storing device, and at least one communication unit for transmitting and receiving data. For example, the system 10, 50 may be comprised in a server connected to the Internet for communicating with the user and merchant machines 18 and 20. In another example, the system 10, 50 may be implemented using a plurality of servers connected together.

In another embodiment, each unit of the systems 10 and 50 is provided with a processing unit, a memory or storing device, and a communication unit for transmitting and receiving data. It should be understood that some units may be regrouped together so that a same processor, a same memory, a same communication unit are shared by at least two units.

The embodiments of the invention described above are intended to be exemplary only. The scope of the invention is therefore intended to be limited solely by the scope of the appended claims.

1. A queueing method for ranking users of a video call platform, the method comprising:
receiving an identification for at least two users who requested to interact with a given merchant via a live video call, and for each one of the at least two users, an identification of a respective item for which the live video call was requested;
determining for each user item information about the respective item;
determining, for each one of the at least two users, at least one characteristic of a respective video call system;
ranking the at least two users as a function of the item information, the at least one characteristic of the video call systems, and a set of predefined rules, thereby obtaining a running order of the at least two users for video calls with the given merchant; and
outputting the running order.

2. The queueing method of claim 1, wherein the item information comprises at least one of a model of the item, a color of the item, a price of the item, an availability of the item, an inventory for the item, shipping options associated with the item, and store pick-up options.

3. The queueing method of claim 1, wherein the at least one characteristic of the respective video call system comprises at least one of a software characteristic of the video call system, a hardware characteristic of the video call system, and an Internet connection characteristic.

4. The queueing method of claim 3, wherein the software characteristic comprises a type of an operating system, a version of the operating system, a type of an Internet browser, a version of the Internet browser, a type of a firewall, and a version of the firewall.

5. The queueing method of claim 3, wherein the hardware characteristic comprises at least one of a type of a video call system, a model of the video call system, a performance of a processor contained in the video call system, a resolution of a display unit of the video call system, a resolution of a camera contained in the video call system, a type of the camera, a model of the camera, a type of a firewall, and a version of the firewall.

6. The queueing method of claim 1, wherein said determining the at least one characteristic of the respective video call system comprises using a fingerprinting method.

7. The queueing method of claim 1, further comprising determining at least one user attribute for each one of the at least two users, and said ranking the at least two users is further performed as a function of the at least one user attribute.

8. The queueing method of claim 1, further comprising determining at least one business attribute for each one of the at least two users, and said ranking the at least two users is further performed as a function of the at least one business attribute.

9. The queueing method of claim 1, further comprising determining at least one attribute of a compatibility between a video call system of the given merchant and the video call system of each one of the at least two users, and said ranking the at least two users is further performed as a function of the at least one attribute of the compatibility.

10. The queueing method of claim 1, wherein said ranking comprises assigning, for each one of the at least two users, a first individual score for the item information using a first one of the predefined rules and a second individual score for the at least one characteristic of the respective video call system using a second one of the predefined rules, and determining for each one of the at least two users a total score using the first and second individual scores, the ranking being performed as a function of the total scores.

11. The queueing method of claim 1, wherein the item comprises a service and the item information comprises at least a type of the service.

12. A queueing device for ranking users of a video call platform, the queueing device comprising:
an item module adapted to receive, for each one of at least two users who requested to interact with a given merchant via a live video call, an identification of a respective item for which the live video call was requested, and retrieve, from a database and for each user, item information about the respective item;
a video system unit adapted to receive an identification for each one of the at least two users; and determine, for each one of the at least two users, at least one characteristic of a respective video call system; and
a ranking module adapted to rank the at least two users as a function of the item information, the at least one characteristic of the video call systems, and a set of predetermined rules, thereby obtaining a running order of the at least two users for video calls with the given merchant, and output the running order.

13. The queueing device of claim 12, wherein the item information comprises at least one of a model of the item, a color of the item, a price of the item, an availability of the item, an inventory of the item, shipping options associated with the item, and store pick-up options.

14. The queueing device of claim 12, wherein the at least one characteristic of the respective video call system comprises at least one of a software characteristic of the video call system, a hardware characteristic of the video call system, and an Internet connection characteristic.

15. The queueing device of claim 14, wherein the software characteristic comprises a type of an operating system, a version of the operating system, a type of an Internet browser, a version of the Internet browser, a type of a firewall, and a version of the firewall.

16. The queueing device of claim 14, wherein the hardware characteristic comprises at least one of a type of the video call system, a model of the video call system, a performance of a processor contained in the video call system, a resolution of a display unit of the video call system, a resolution of a camera contained in the video call system, a type of the camera, a model of the camera, a type of a firewall, and a version of the firewall.

17. The queueing device of claim 12, wherein the video system unit is adapted to determine the at least one characteristic of the respective video call system using a fingerprinting method.

18. The queueing device of claim 12, further comprising a user unit adapted to determine at least one user attribute for each one of the at least two users, the ranking unit being further adapted to rank the at least two users as a function of the at least one user attribute.

19. The queueing device of claim 12, further comprising a business unit adapted to determine at least one business attribute for each one of the at least two users, the ranking unit being further adapted to rank the at least two users as a function of the at least one business attribute.

20. The queueing device of claim 12, further comprising a compatibility unit adapted to determine at least one attribute of a compatibility between a video call system of the given merchant and the video call system of each one of the at least two users, the ranking unit being further adapted to rank the at least two users as a function of the at least one attribute of the compatibility.

21. The queueing device of claim 12, wherein the item module is adapted to assign, for each one of the at least two users, a first individual score for the item information using a first one of the predetermined rules, the video system unit is adapted to assign a second individual score for the at least one characteristic of the respective video call system using a second one of the predetermined rules, and the ranking unit is adapted to determine for each one of the at least two users a total score using the first and second individual scores, the ranking being performed as a function of the total scores.

22. The queueing device of claim 12, wherein the item comprises a service and the item information comprises at least a type of the service.
